(19) United States
(12) Patent Application Publication
(10) Pub. No.: US 2010/0318949 A1
(43) Pub. Date: Dec. 16, 2010

(54) COMPUTER PRODUCT, DESIGN SUPPORT APPARATUS, AND DESIGN SUPPORT METHOD

(75) Inventors: Akio SAKAMOTO, Kawasaki (JP); Akira Sakai, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/790,980

(22) Filed: May 31, 2010

(30) Foreign Application Priority Data
Jun. 10, 2009 (JP) 2009-139682

(51) Int. Cl. G06F 17/50

(52) U.S. Cl. 716/106

(57) ABSTRACT

A non-transitory computer-readable recording medium stores therein a design support program that causes a computer capable of accessing a database, which stores therein respective starting point and ending point coordinates of line segments included in a wiring path of a circuit-under-test, to execute a process that includes dividing a layout area of the circuit-under-test, by a predetermined width, into a grid pattern to divide the layout area into plural mesh areas, using a predetermined coordinate within the layout area as an origin coordinate; determining whether a line segment selected from among the line segments in the database passes through a vertex of a mesh area obtained at the dividing; and outputting a determination result obtained at the determining.

### CROSS REFERENCE TO RELATED APPLICATIONS

This application is based upon and claims the benefit of priority of the prior Japanese Patent Application No. 2009-139682, filed on Jun. 10, 2009, the entire contents of which are incorporated herein by reference.

### FIELD

The embodiment discussed herein is related to design support for a semiconductor integrated circuit.

### BACKGROUND

Recently, accompanying higher densities and higher speeds of semiconductor integrated circuits, various noise-related problems such as crosstalk/reflection noise and waveform distortion due to dielectric loss, occur in printed circuit boards (PCBs) having ultrahigh-speed semiconductor components. Thus, at the time of design, it has become important to analyze propagation-related noise of printed circuit boards and take appropriate measures against noise.

Generally, in the analysis of propagation-related noise of a PCB, a wiring model is prepared by simplifying a wiring pattern on the PCB, using a computer-aided design (CAD) model. Propagation noise is analyzed by setting various conditions (e.g., mesh origin, a physical property, execution conditions, etc.) to analyze the wiring model using an analysis tool.

Among conventional approaches for preparing a wiring model is an approach of dividing a layout area of a PBC into plural mesh areas and discerning the wiring pattern for each mesh area (see, for example, Japanese Laid-open Patent Publication No. 2005-50137).

FIG. 28 is an explanatory diagram of one example of the conventional technique. FIG. 28 depicts wiring 2810 on a PCB 2800. A portion extracted from the PCB 2800 is depicted in FIG. 28. Here, a wiring path 2820 is a path running through a central portion of the wiring 2810. In the conventional technique, the wiring model (hatched portion of FIG. 28) of the wiring 2810 is prepared by recognizing mesh areas intersected by the wiring path 2820.

The conventional technique described above, however, has a problem in that for wiring passing through a vertex of a mesh area, the analysis tool recognizes the wiring model as non-continuous and the propagation noise analysis may not be performed appropriately. In the example depicted in FIG. 28, since the wiring path 2810 passes through a vertex F of a mesh area, the wiring model becomes non-continuous. Specifically, the mesh area Mc or the mesh area Md that connects the mesh area Ma and the mesh area Mb is not recognized and the wiring model becomes non-continuous.

In such a case, the user is required to identify a non-continuous point of the wiring model and make a modification such as add a mesh area (e.g., mesh area Mc or Md) to compensate continuity of the wiring model. As a result, there is a problem of increased work load and time required for the preparation of the wiring model, which leads to a longer design period.

### SUMMARY

According to an aspect of an embodiment, a non-transitory computer-readable recording medium stores therein a design support program that causes a computer capable of accessing a database, which stores therein respective starting point and ending point coordinates of line segments included in a wiring path of a circuit-under-test, to execute a process that includes dividing a layout area of the circuit-under-test, by a predetermined width, into a grid pattern to divide the layout area into plural mesh areas, using a predetermined coordinate within the layout area as an origin coordinate; determining whether a line segment selected from among the line segments in the database passes through a vertex of a mesh area obtained at the dividing; and outputting a determination result obtained at the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of one example of an outline of the present design support technique.

FIG. 2 is a block diagram of a design support apparatus according to an embodiment.

FIG. 3 is an explanatory diagram of one example of a circuit-under-test.

FIG. 4 is an explanatory diagram of one example of the contents of a line data DB.

FIG. 5 is a functional diagram of the design support apparatus.

FIG. 6 is an explanatory diagram of an example of mesh area division.

FIG. 7 is an explanatory diagram of one example of mesh position information.

FIG. 8 is an explanatory diagram of a mesh area detection example.

FIG. 9 is an explanatory diagram of one example of the contents of a first detection result table.

FIG. 10 is an explanatory diagram of one example of a first detection result.

FIG. 11 is an explanatory diagram of a search example for a string of mesh areas.

FIG. 12 is an explanatory diagram of one example the contents of a search result table.

FIG. 13 is an explanatory diagram of one example of non-continuous line report information.

FIG. 14 is an explanatory diagram of another example of mesh area division.

FIG. 15 is an explanatory diagram of another example of mesh area detection.

FIG. 16 is an explanatory diagram of an example of merging the first and second detection results.

FIG. 17 is an explanatory diagram of another example of searching for a mesh area string.

FIG. 18 is an explanatory diagram of another example of the contents of the search result table.

FIG. 19 is an explanatory diagram of another example of mesh area division.

FIG. 20 is an explanatory diagram of another example of mesh area detection.

FIG. 21 is an explanatory diagram of an example of merging the first, the second, and third detection results.

FIG. 22 is an explanatory diagram of another example of searching for a mesh area string.

FIG. 23 is a flowchart of one example of a design supporting procedure of the design support apparatus according to the embodiment.

FIG. 24 is a flowchart of one example of first detection processing at step S2304.

FIG. 25 is a flowchart of one example of first search processing at step S2305.

FIG. 26 is a flowchart of one example of determination processing at step S2306.

FIG. 27 is a flowchart of one example of offset processing at step S2307.

FIG. 28 is an explanatory diagram of one example of the conventional technique.

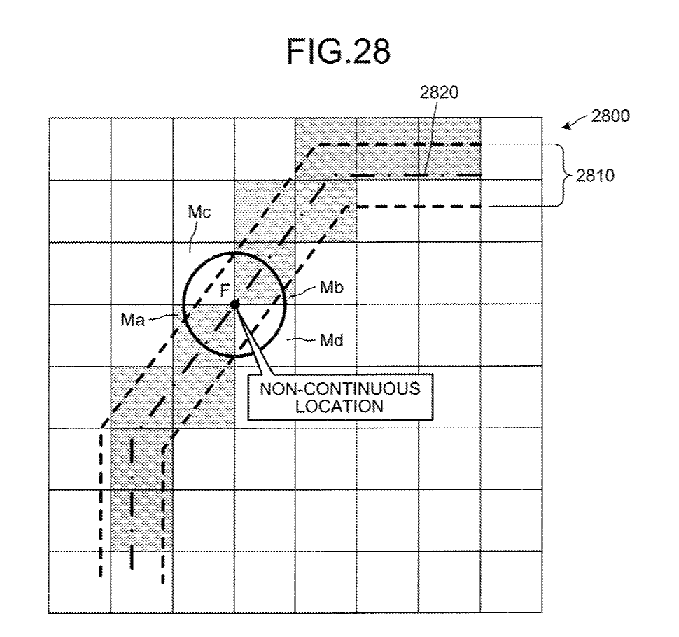

### DESCRIPTION OF EMBODIMENTS

An embodiment of the present invention will be explained with reference to the accompanying drawings.

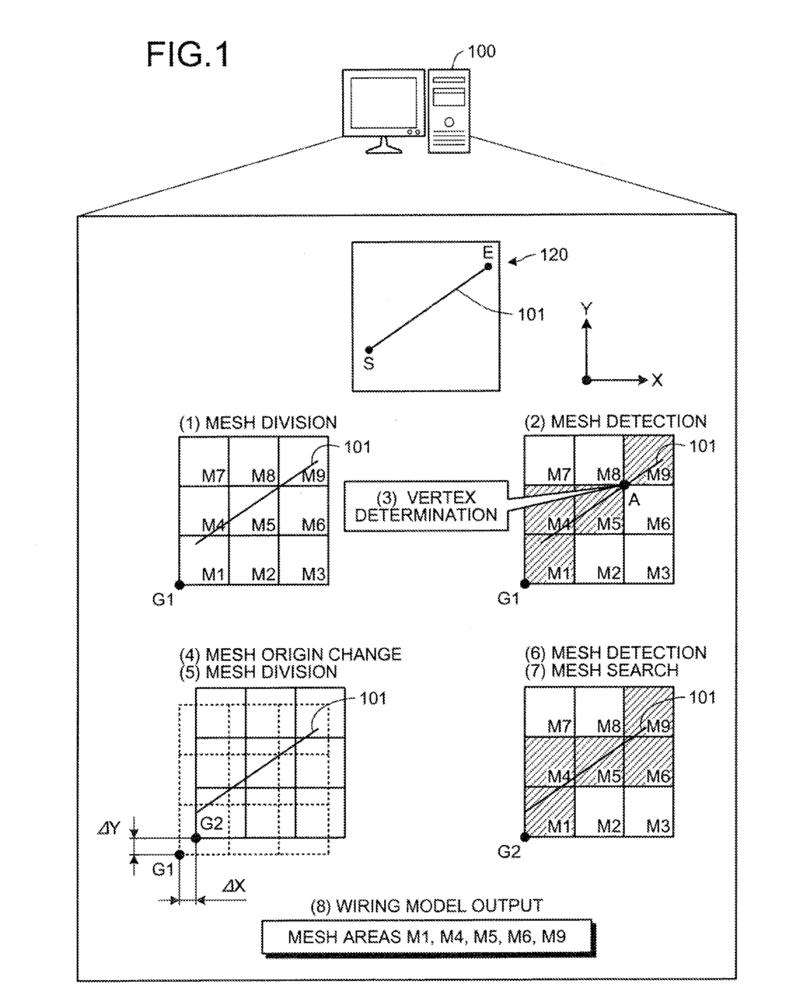

FIG. 1 is an explanatory diagram of one example of an outline of the present design support technique.

Here, description will be given of a case of generating, according to the present design support technique, a wiring model to be used for propagation noise analysis of a circuit-under-test such as a PCB.

As depicted in FIG. 1, a design support apparatus 100 has a function of generating a simplified wiring model of a wiring path within the circuit-under-test. A procedure of generating a wiring model for a wiring path 101 on a PCB 120 will be described. Point S is the starting point of the wiring path 101 and point E is the ending point.

(1) The design support apparatus 100 divides, in an orthogonal coordinate system consisting of X and Y axes, a layout area of the PCB 120 into plural mesh areas forming a grid pattern, where a point G1 is a mesh origin. Here, the layout area of the PCB 120 is divided into mesh areas M1 to M9.

(2) The design support apparatus 100, with point G1 as the mesh origin and from among the mesh areas M1 to M9, detects mesh areas intersected by the wiring path 101. Here, the mesh areas M1, M4, M5, and M9 are detected.

(3) The design support apparatus 100 determines whether the wiring path 101 passes through a vertex of a mesh area. Here, it is determined that the wiring path 101 passes through a vertex A. In this case, the analysis tool that executes the propagation noise analysis will recognize the wiring model of the wiring path 101 as non-continuous.

Therefore, passage of the wiring path 101 through the vertex of the mesh area is circumvented by the following procedures (4) through (7) to compensate the continuity of the wiring model.

(4) The design support apparatus 100 changes the mesh origin from point G1 to point G2. Here, point G2 is a point obtained by shifting point G1 by ΔX and ΔY along the directions of the X and Y axes, respectively.

(5) The design support apparatus 100 divides, in an orthogonal coordinate system consisting of X and Y axes, a layout area of the PCB 120 into plural mesh areas forming a grid pattern, where a point G2 is the mesh origin. Here, the layout area of the PCB 120 is divided into mesh areas M1 to M9, i.e., the mesh origin is changed to shift the position of the mesh areas and thereby, circumvent the passage of the wiring path 101 through a vertex of a mesh area.

(6) The design support apparatus 100, with point G2 as the mesh origin and from among the mesh areas M1 to M9, detects mesh areas intersected by the wiring path 101. Here, the mesh areas M1, M4, M5, M6, and M9 are detected.

(7) The design support apparatus 100 merges results of detection at (2) and (6) above and searches for a string of mesh areas as the wiring path 101 from the starting point S to the ending point E. Here, the mesh areas M1, M4, M5, M6, and M9 are retrieved.

(8) The design support apparatus 100 outputs the retrieved mesh areas M1, M4, M5, M6, and M9 as the wiring model of the wiring path 101.

In this way, according to the present design support technique, a position (vertex A) where the wiring model of the wiring path 101 becomes non-continuous is identified so that the continuity of the wiring model can be compensated. Here, the continuity of the wiring model is compensated by the mesh area M6 connecting the mesh areas M5 and M9, thereby enabling reduction of the time and labor involved in generating the wiring model and thus, shortening the design period.

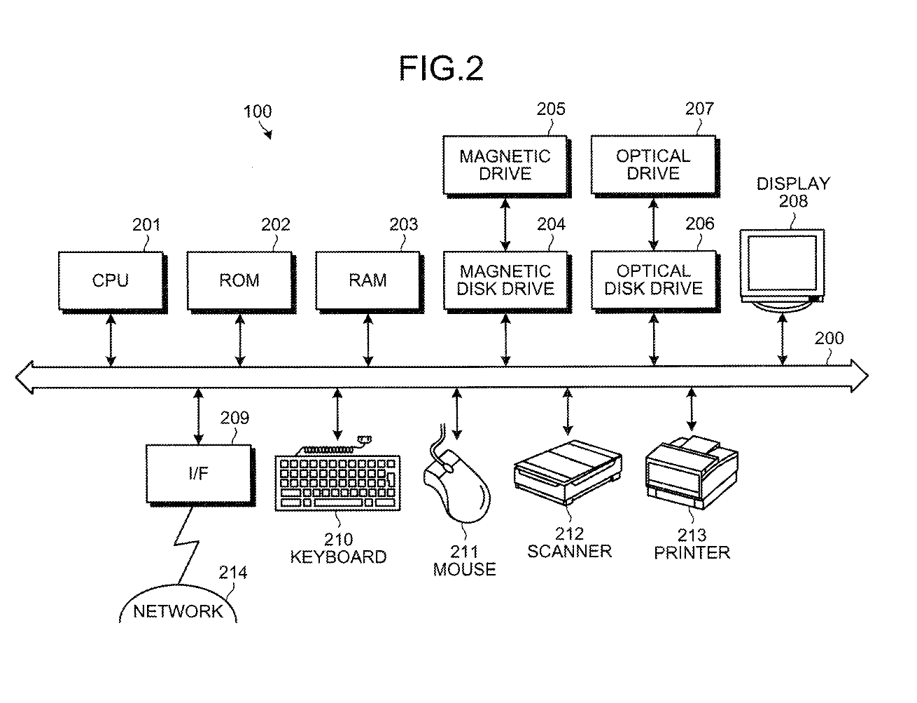

FIG. 2 is a block diagram of a design support apparatus according to the embodiment. As depicted in FIG. 2, a design support apparatus 100 includes a central processing unit (CPU) 201, a read-only memory (ROM) 202, a random access memory (RAM) 203, a magnetic disk drive 204, a magnetic disk 205, an optical disk drive 206, an optical disk 207, a display 208, an interface (I/F) 209, a keyboard 210, a mouse 211, a scanner 212, and a printer 213, respectively connected by a bus 200.

The CPU 201 governs overall control of the design support apparatus 100. The ROM 202 stores therein programs such as a boot program. The RAM 203 is used as a work area of the CPU 201. The magnetic disk drive 204, under the control of the CPU 201, controls the reading and writing of data with respect to the magnetic disk 205. The magnetic disk 205 stores therein data written under control of the magnetic disk drive 204.

The optical disk drive 206, under the control of the CPU 201, controls the reading and writing of data with respect to the optical disk 207. The optical disk 207 stores therein data written under control of the optical disk drive 206, the data being read by a computer.

The display 208 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 208.

The I/F 209 is connected to a network 214 such as a local area network (LAN), a wide area network (WAN), and the Internet through a communication line and is connected to other apparatuses through the network 214. The I/F 209 administers an internal interface with the network 214 and controls the input/output of data from/to external apparatuses. For example, a modem or a LAN adaptor may be employed as the I/F 209.

The keyboard 210 includes, for example, keys for inputting letters, numerals, and various instructions and performs the input of data. Alternatively, a touch-panel-type input pad or numeric keypad, etc. may be adopted. The mouse 211 is used to move the cursor, select a region, or move and change the size of windows. A track ball or a joy stick may be adopted provided each respectively has a function similar to a pointing device.

The scanner 212 optically reads an image and takes in the image data into the design support apparatus 100. The scanner 212 may have an optical character recognition (OCR) function as well. The printer 213 prints image data and text data. The printer 213 may be, for example, a laser printer or an ink jet printer.

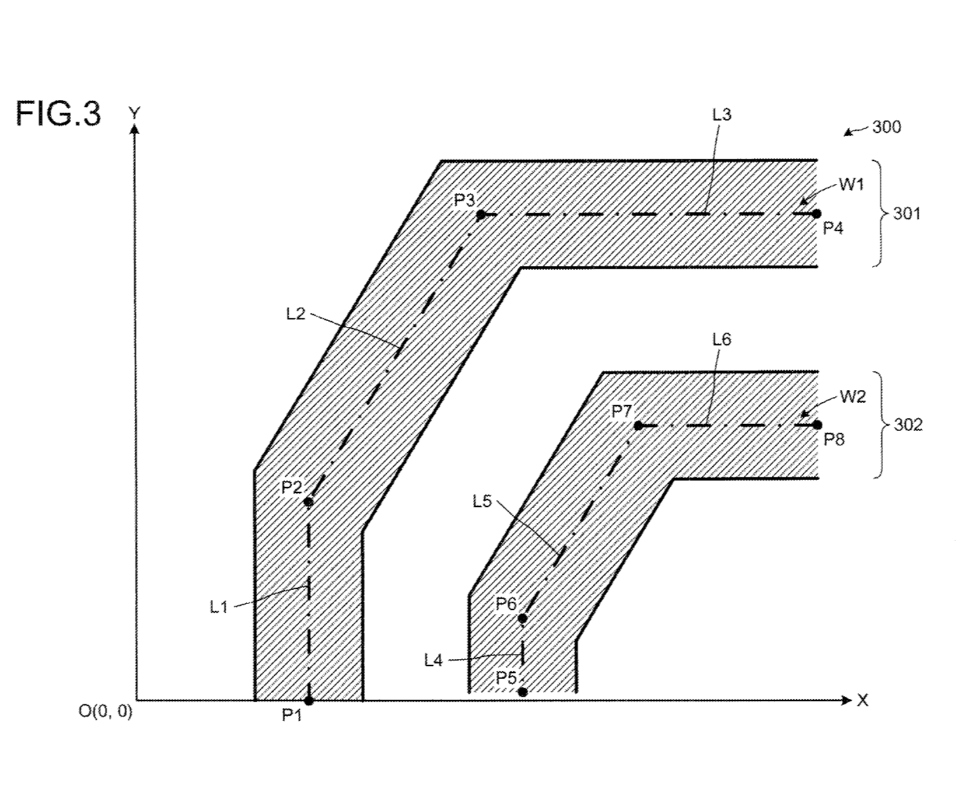

FIG. 3 is an explanatory diagram of one example of the circuit-under-test. As depicted in FIG. 3, a circuit-under-test 300 is an electronic circuit that includes wirings 301 and 302. In an orthogonal coordinate system consisting of X and Y axes, point O is the origin of the layout area for the circuit-under-test 300. A portion extracted from the circuit-under-test 300 is depicted in FIG. 3.

Here, a wiring path W1 (chain line in FIG. 3) is a path that passes through a central portion of the wiring 301 and includes lines L1, L2, and L3. In the wiring path W1, point P1 is the starting point of the line L1 and point P2 is the ending point thereof. Point P2 is the starting point of the line L2 and point P3 is the ending point thereof. Point P3 is the starting point of the line L3 and point P4 is the ending point thereof.

Further, a wiring path W2 (chain line in FIG. 3) is a path that passes through a central portion of the wiring 302 and includes lines L4, L5, and L6. In the wiring path W2, point P5 is the starting point of the line L4 and point P6 is the ending point thereof. Point P6 is the starting point of the line L5 and point P7 is the ending point thereof. Point P7 is the starting point of the line L6 and point P8 is the ending point thereof.

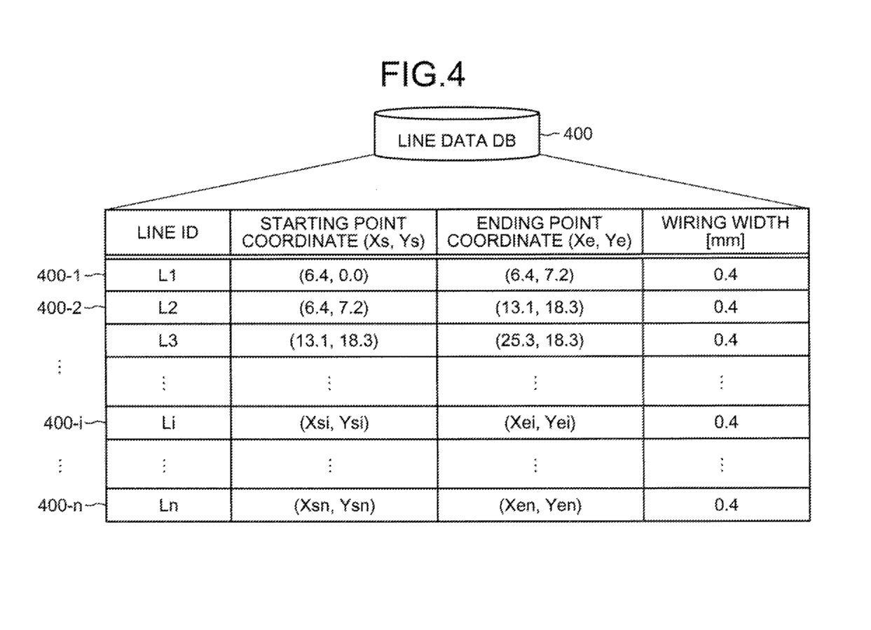

FIG. 4 is an explanatory diagram of one example of the contents of a line data DB used by the design support apparatus 100. As depicted in FIG. 4, a line data DB 400 has fields for line ID, starting point coordinates, ending point coordinates, and wiring width. With information set for each field, line data 400-1 to 400-n are stored as records.

Here, a line ID is an identifier for a line (L1 to Ln) included in a wiring path (e.g., wiring paths W1 and W2) of the circuit-under-test 300 depicted in FIG. 3. Starting point coordinates indicate the position (in the orthogonal coordinate system of the X and Y axes) of the starting point of the line (L1 to Ln). Ending point coordinates indicate the position of the ending point of the line (L1 to Ln). A wiring width is the width of the wiring that includes the line (L1 to Ln).

Taking the line data 400-2 as an example, the starting point coordinates (point P2 in FIG. 3) of the line L2 are (6.4, 7.2), the ending point coordinates (point P3 in FIG. 3) thereof are (13.1, 18.3), and the wiring width thereof is 0.4 [mm]. The line data DB 400 is stored in a storage device such as the ROM 202, the RAM 203, the magnetic disk 205, and the optical disk 207 depicted in FIG. 2.

In the following description, an arbitrary line selected from among the lines L1 to Ln is expressed as “Li”, where “i=1, 2, . . . , n”. The starting point coordinates of the line Li are (Xsi, Ysi), the ending point coordinates thereof are (Xei, Yei), and the wiring width thereof is 0.4 [mm].

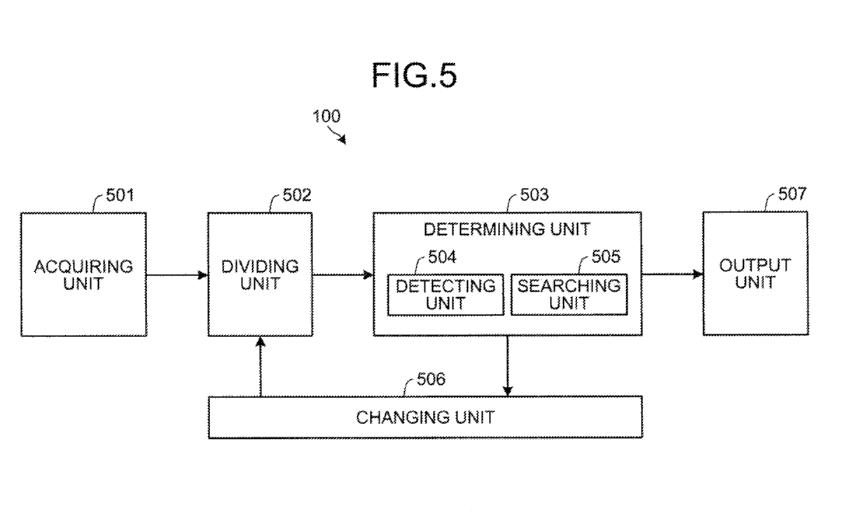

FIG. 5 is a functional diagram of the design support apparatus. As depicted in FIG. 5, the design support apparatus 100 is configured to include an acquiring unit 501, a dividing unit 502, a determining unit 503, a detecting unit 504, a searching unit 505, a changing unit 506, and an output unit 507. A function, as a controller (the acquiring unit 501 through the output unit 507) of the design support apparatus, is implemented by causing the CPU 201 to execute a program stored in a storage device such as the ROM 202, the RAM 203, the magnetic disk 205 and the optical disk 207, or by the I/F 209.

The acquiring unit 501 has a function of acquiring the line data, which includes the starting point/ending point coordinates of each line segment in a wiring path in the circuit-under-test. Here, the circuit-under-test is, for example, a PCB having plural electronic components arranged/wired thereon. A wiring path is wiring interconnecting the electronic components and includes at least one line segment.

For example, the acquiring unit 501 acquires the line data 400-1 to 400-n (see FIG. 4) by user input via the keyboard 210 or the mouse 211. The acquiring unit 501 may acquire the line data 400-1 to 400-n by extraction from the design data of the circuit-under-test 300. The acquired line data is stored to, for example, the line data DB 400 depicted in FIG. 4.

The acquiring unit 501 has a function of acquiring dividing conditions for dividing the layout area of the circuit-under-test. Here, the dividing conditions are information including, for example, the wiring width of the wiring path within the circuit-under-test and the coordinates of the mesh origin. The mesh origin is a reference point for dividing the layout area into a grid pattern and is arbitrarily settable (e.g., the origin of the layout area).

For example, the acquiring unit 501 acquires the dividing conditions by user input via the keyboard 210 or the mouse 211, and acquires the wiring width by, for example, extraction from the design data of the circuit-under-test 300. The acquired dividing conditions are stored to, for example, a storage device such as the RAM 203, the magnetic disk 205, and the optical disk 207.

Hereinafter, in the present specification a circuit-under-test will be described as the circuit-under-test 300 depicted in FIG. 3 and a line segment in a wiring path within the circuit-under-test will be described as any one among the lines L1 to Ln. The mesh origin will be described as the origin O (0, 0) of the layout area for the circuit-under-test 300.

The dividing unit 502 has a function of dividing a layout area of the circuit-under-test 300, by a predetermined width, into a grid pattern to segment the layout area into plural mesh areas, based on predetermined coordinates in the layout area taken as origin coordinates. Here, the predetermined coordinates are the coordinates of the mesh origin included in the acquired dividing conditions. The predetermined width is a mesh width representing the length of a side of each mesh area.

The mesh width (predetermined width) may be pre-stored in a storage device such as the RAM 203, the magnetic disk 205, and the optical disk 207 or may be obtained using equation (1), where M represents the mesh width, w represents the wiring width, and α represents an arbitrary constant of 3 or more.

M=w/α (1)

Here, α above is assumed as “4”. The wiring width of the wiring path in the circuit-under-test 300 is 0.4 [mm] and the coordinate of the mesh origin is (X, Y)=(0, 0). Therefore, from equation (1), the mesh width is “M=0.4/4=0.1 [mm]”. In this case, with the mesh origin (0, 0) as a reference, the dividing unit 502 divides the layout area into a grid pattern by a mesh width of 0.1 [mm], obtaining plural mesh areas.

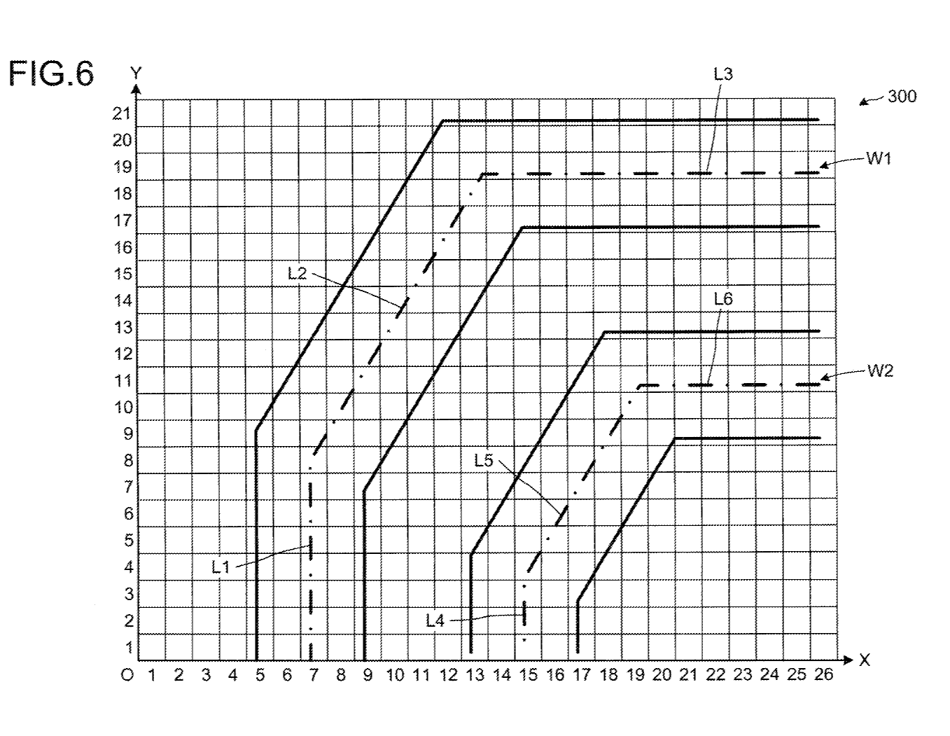

FIG. 6 is an explanatory diagram of an example of mesh area division. In FIG. 6, with point O (0, 0) as the mesh origin, the layout area of the circuit-under-test 300 is divided into plural mesh areas by a mesh width of 0.1 [mm]. A portion extracted from the circuit-under-test 300 is depicted in FIG. 6.

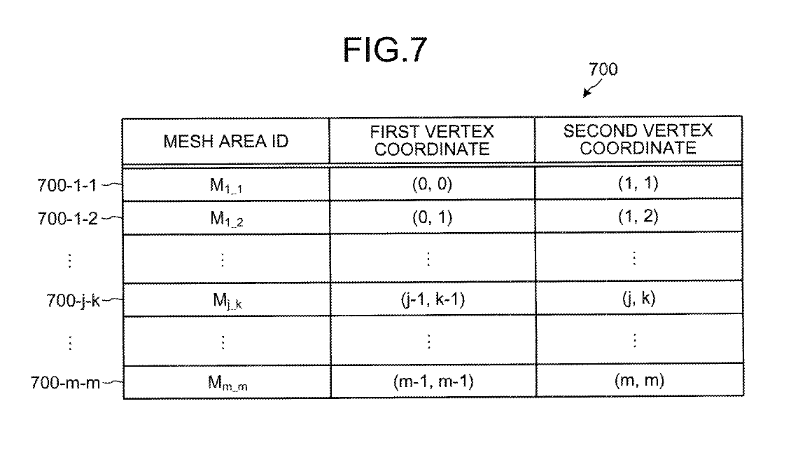

In FIG. 6, numerals along the X and Y axes are for identifying mesh area IDs. Results of the division are stored, for example, as mesh position information 700 (see FIG. 7), to a storage device such as the RAM 203, the magnetic disk 205, and the optical disk 207.

FIG. 7 is an explanatory diagram of one example of the mesh position information. As depicted in FIG. 7, mesh position information 700 includes fields for the mesh area ID, a first vertex coordinate, and a second vertex coordinate. With information set for each field, the mesh position information 700-1-1 to 400-m-m is stored as records.

Here, a mesh area ID is an identifier for identifying a mesh area (M₁_{_{—}}₁ to Mₘ_{_{—}}ₘ). The first and the second vertex coordinates are coordinates of two diagonal vertexes of the mesh area (M₁_{_{—}}₁ to Mₘ_{_{—}}ₘ). Taking the mesh position information 700-1-2 as an example, the first vertex coordinate of the mesh area M₁_{_{—}}₂ is (0, 1) and the second vertex coordinate thereof is (1, 2).

In the following description, an arbitrary mesh area from among the mesh areas M₁_{_{—}}₁ to Mₘ_{_{—}}ₘ is expressed as “mesh area Mⱼ_{_{—}}ₖ”, where “j=1, 2, . . . , m and k=1, 2, . . . , m”. The first vertex coordinate of the mesh area Mⱼ_{_{—}}ₖ is (j−1, k−1) and the second vertex coordinate thereof is (j, k).

The reference of description returns to FIG. 5. The determining unit 503 has a function of determining whether an arbitrary line Li selected from among lines L1 to Ln in the circuit-under-test 300 passes through a vertex of a mesh area. For example, the determining unit 503 refers to the line data DB 400 and the mesh position information 700 to determine whether the line Li passes through a vertex of a mesh area (M₁_{_{—}}₁ to Mₘ_{_{—}}ₘ).

A specific example will be described of determination processing by the determining unit 503. The detecting unit 504 detects a mesh area having the starting point coordinates (Xsi, Ysi) of the line Li, from among the mesh areas M₁_{_{—}}₁ to Mₘ_{_{—}}ₘ. For example, the detecting unit 504 detects a mesh area Mⱼ_{_{—}}ₖ that satisfies “j−1≦Xsi≦j” and “k−1≦Ysi≦k”, from among the mesh areas M₁_{_{—}}₁ to Mₘ_{_{—}}ₘ.

The detecting unit 504 detects a mesh area having the ending point coordinates (Xei, Yei) of the line Li, from among the mesh areas M₁_{_{—}}₁ to Mₘ_{_{—}}ₘ. For example, the detecting unit 504 detects a mesh area Mⱼ_{_{—}}ₖ that satisfies “j−1≦Xei≦j” and “k−1≦Yei≦k”, from among the mesh areas M₁_{_{—}}₁ to Mₘ_{_{—}}ₘ.

The detecting unit 504 has a function of detecting a mesh area having two or more intersections with the line Li at a boundary, from among the mesh areas M₁_{_{—}}₁ to Mₘ_{_{—}}ₘ. For example, the detecting unit 504 obtains an equation for a straight line connecting the starting point coordinates (Xsi, Ysi) and the ending point coordinates (Xei, Yei) of the line Li.

The equation of the line Li is obtained as any one of the following equations (2) to (4), where x is “Xsi≦x≦Xei”, y is “Ysi≦y≦Yei”, and a is a constant.

y=x(Yei−Ysi)/(Xei−Xsi)+a (2)

y=Ysi=Yei (3)

x=Xsi=Xei (4)

The detecting unit 504 then obtains the intersection of the line Li with four boundary lines Bⱼₖ1 to Bⱼₖ4 of the mesh area Mⱼ_{_{—}}ₖ. Here, the boundary line Bⱼₖ1 is the line segment connecting the coordinate (j−1, k−1) and the coordinate (j, k−1). The boundary line Bⱼₖ2 is the line segment connecting the coordinate (j−1, k−1) and the coordinate (j−1, k). The boundary line Bⱼₖ3 is the line segment connecting the coordinate (j−1, k) and the coordinate (j, k). The boundary line Bⱼₖ4 is the line segment connecting the coordinate (j, k−1) and the coordinate (j, k).

The detecting unit 504 detects a mesh area Mⱼ_{_{—}}ₖ having two or more boundary lines Bⱼₖ1 to Bⱼₖ4 that are intersected by the line Li. If the line Li overlaps any of the boundary lines Bⱼₖ1 to Bⱼₖ4, the detecting unit 504 detects any one among the mesh area Mⱼ_{_{—}}ₖ and the mesh area adjacent to the mesh area Mⱼ_{_{—}}ₖ at the overlapped boundary line.

For example, assuming that the line Li is “y=k”, the line Li overlaps the boundary line Bⱼₖ3 of the mesh area Mⱼ_{_{—}}ₖ and at the same time, overlaps the boundary line Bⱼ₍ₖ₊ⱼ₎1 of the mesh area Mⱼ_{_{—}}₍ₖ₊₁₎. In this case, the detecting unit 504 detects any one of the mesh area Mⱼ_{_{—}}ₖ and the mesh area Mⱼ_{_{—}}₍ₖ₊₁₎.

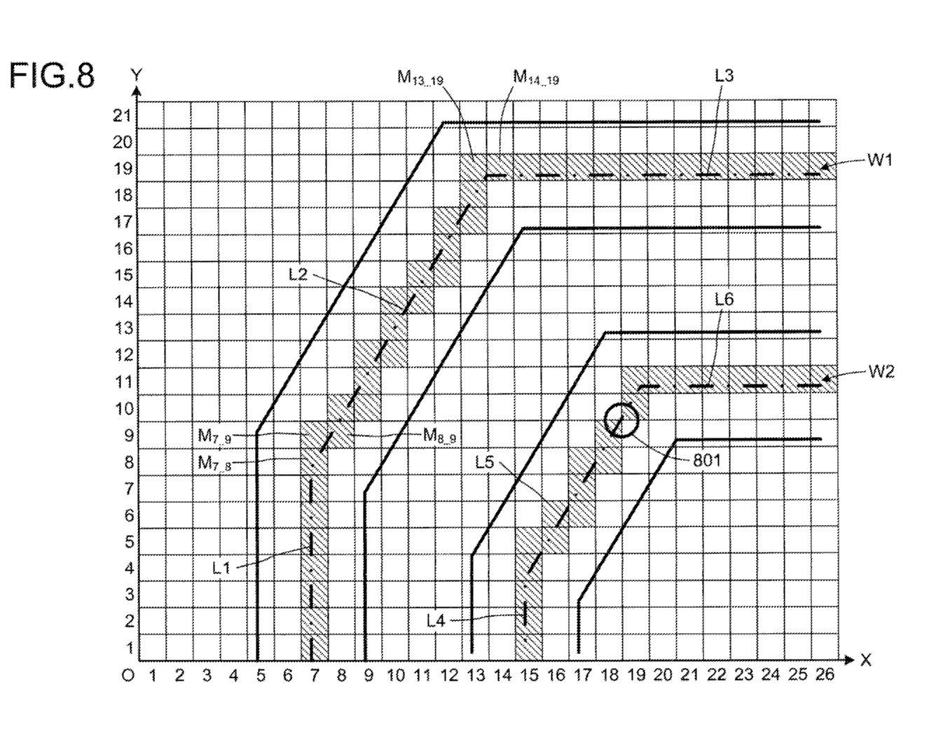

FIG. 8 is an explanatory diagram of a mesh area detection example. In FIG. 8, the detection example (hatched portion in FIG. 8) is depicted with respect to the lines L1 to L3 in the wiring path W1 and the lines L4 to L6 in the wiring path W2.

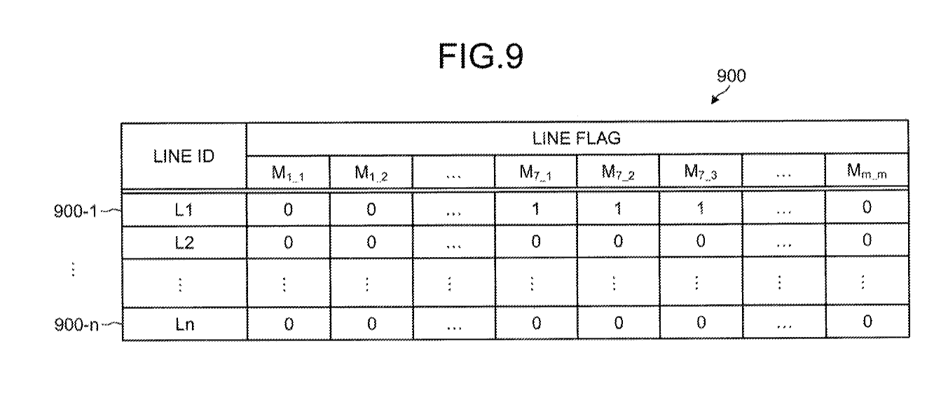

Taking the line L2 as an example, detection is depicted for the mesh area M₇₋₈ having the starting point coordinates (6.4, 7.2) of the line L2 and the mesh area M₁₄₋₁₉ having the ending point coordinates (13.1, 18.3) of the line L2. Further, the mesh areas M₇₋₉, M₈₋₉, . . . . M₁₃₋₁₉ are detected as mesh areas having two or more boundary lines intersected by the line L2. Results of the detection are stored to, for example, a first detection result table 900 (see FIG. 9).

FIG. 9 is an explanatory diagram of one example of the contents of the first detection result table. In FIG. 9, the first detection result table 900 has fields for line ID and a line flag, and stores detection results 900-1 to 900-n according to line (the lines L1 to Ln), as records. The line flag field has a subfield for each mesh area.

A line ID is an identifier for a line (L1 to Ln). Each line flag is a flag representing the detection results for the lines L1 to Ln, respectively. Here, “1” is set for a mesh area having the starting point coordinates of the line Li, a mesh area having the ending point coordinates of the line Li, and a mesh area having two or more boundary lines intersected by the line Li. The line flag is “0” in the initial state. The first detection result table 900 is stored to a storage device such as the RAM 203, the magnetic disk 205, and the optical disk 207.

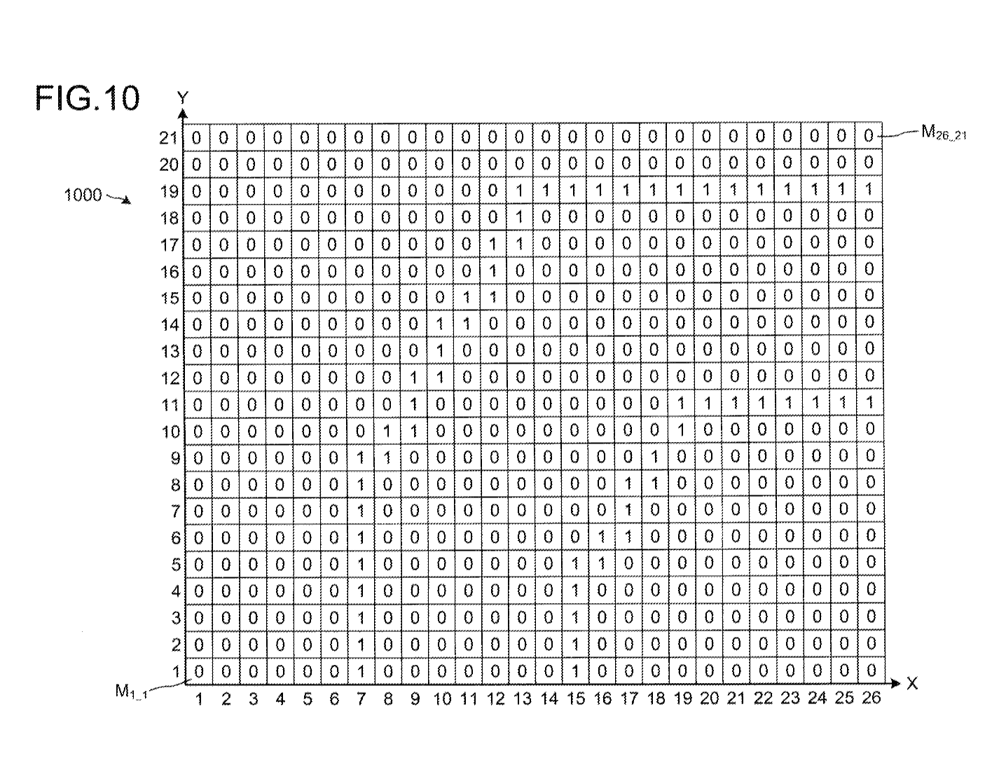

An image of a first detection result will be described that represents an image of the detection results 900-1 to 900-6, taking the lines L1 to Ln as an example. FIG. 10 is an explanatory diagram of one example of the first detection result.

As depicted in FIG. 10, a first detection result image 1000 displays mesh areas M₁_{_{—}}₁ to M₂₆_{_{—}}₂₁ divided from the layout area of the circuit-under-test 300. Among the mesh areas M₁_{_{—}}₁ to M₂₆_{_{—}}₂₁, “1” is indicated at the mesh areas for at least the line flags of the lines L1 to L6 having a value of “1”, and “0” is indicated at other mesh areas.

Reference of the description returns to FIG. 5. The searching unit 505 has a function of searching the detected mesh areas, for a string of mesh areas, starting from the mesh area having the starting point coordinates of the line Li and successively tracing adjacent mesh areas sharing a boundary line. For example, the searching unit 505 firstly determines the slope Si (=(Yei−Ysi)/(Xei−Xsi)) of the line L1. The searching unit 505 then performs any one of the following search processing (i) through (iii) according to the slope Si of the line Li.

(i) If the slope Si of the line Li is positive (according to equation (2)): The searching unit 505 selects the mesh area Mⱼ_{_{—}}ₖ having the starting point coordinates of the line Li. The searching unit 505 then refers to the first detection result table 900 to search for a mesh area for which the line flag of the line Li is “1” among the mesh areas Mⱼ₊₁_{_{—}}ₖ and Mⱼ_{_{—}}ₖ₊₁. Thereafter, the searching unit 505 repeats the processing, with the mesh area to be searched (mesh area Mⱼ₊₁_{_{—}}ₖ or Mⱼ_{_{—}}ₖ₊₁.) regarded as the mesh area Mⱼ_{_{—}}ₖ. The search processing is finished when each of the line flags of the mesh areas Mⱼ₊₁_{_{—}}ₖ and Mⱼ_{_{—}}ₖ₊₁ as the mesh areas to be searched are “0”. A mesh area that has been searched is excluded from the mesh areas to be searched.

(ii) If the slope Si of the line Li is negative (according to equation (2)): The searching unit 505 selects the mesh area Mⱼ_{_{—}}ₖ having the starting point coordinates of the line Li. The searching unit 505 then refers to the first detection result table 900 to search for a mesh area for which the line flag of the line Li is “1”, among the mesh areas Mᵢ₊₁_{_{—}}ₖ and Mⱼ_{_{—}}ₖ₋₁. Thereafter, the searching unit 505 repeats the processing, with the mesh area to be searched (mesh area Mⱼ₊₁_{_{—}}ₖ or Mⱼ_{_{—}}ₖ₋₁.) regarded as the mesh area Mⱼ_{_{—}}ₖ. The search processing is finished when each of the line flags of the mesh areas Mᵢ₊₁_{_{—}}ₖ and Mⱼ_{_{—}}ₖ₋₁ as the mesh areas to be searched are “0”. A mesh area that has been searched is excluded from the mesh areas to be searched.

(iii) If the slope Si of the line Li is nonexistent (according to equation (3) or (4) above): The searching unit 505 refers to the detection results 900-i of the first detection result table 900 and regards the mesh areas for which the line flag is “1” as the string of mesh areas of the line Li.

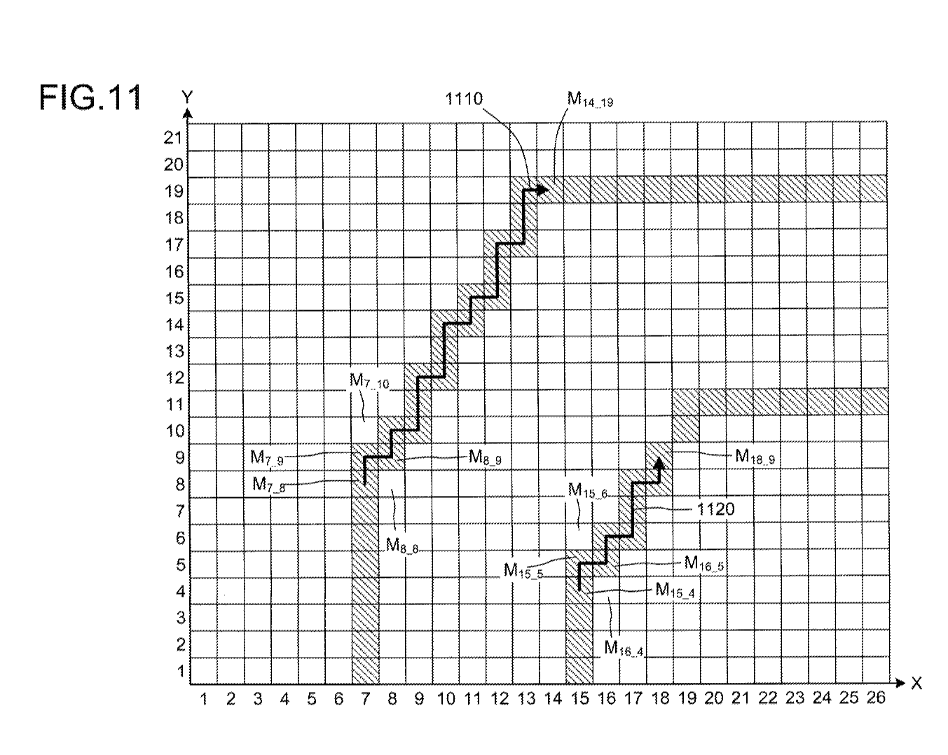

A search example for the string of mesh areas will be described, taking the lines L2 and L5 as an example. The slope S2 of the line L2 is positive and the slope S5 of the line L5 is positive. FIG. 11 is an explanatory diagram of a search example for a string of mesh areas.

In FIG. 11, route 1110 represents search results with respect to the line L2. Specifically, the searching unit 505 firstly retrieves the mesh area M₇₋₉ for which the line flag of the line L2 is “1”, from among the mesh areas M₈₋₈ and M₇₋₉ adjacent to the mesh area M₇₋₈ having the starting point coordinates of the line L2 (see FIG. 10).

The searching unit 505 then retrieves the mesh area M₈₋₉ for which the line flag of the line L2 is “1”, from among the mesh areas M₈₋₉ and M₇₋₁₀ adjacent to the mesh area M₇₋₉. Thereafter, the processing is repeated until each of the line flags of the mesh areas to be searched are “0”. As a result, the search processing is finished when the mesh area M₁₄₋₁₉ is retrieved.

In FIG. 11, route 1120 represents search results with respect to the line L5. Specifically, the searching unit 505 firstly retrieves the mesh area M₁₅₋₅ for which the line flag of the line L5 is “1”, from among the mesh areas M₁₆₋₄ and M₁₅₋₅ adjacent to the mesh area M₁₅₋₄ having the starting point coordinates of the line L2 (see FIG. 10).

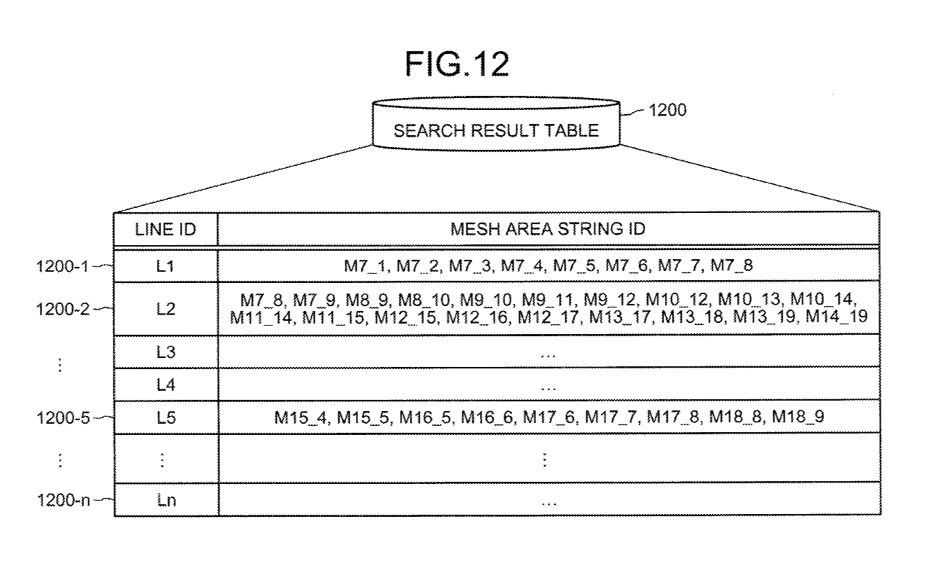

The searching unit 505 then retrieves the mesh area M₁₆₋₅ for which the line flag of the line L5 is “1”, from among the mesh areas M₁₆₋₅ and M₁₅₋₆ adjacent to the mesh area M₁₅₋₅. Thereafter, the processing is repeated until each of the line flags of the mesh areas to be searched are “0”. As a result, the search processing is finished when the mesh area M₁₈₋₉ is retrieved. The search results are stored to, for example, the search result table 1200 depicted in FIG. 12.

FIG. 12 is an explanatory diagram of one example the contents of the search result table. As depicted in FIG. 12, a search result table 1200 has fields for a line ID and a mesh area string ID. With information set for each field, the search results 1200-1 to 1200-n are stored as records.

Here, a line ID is an identifier for a line (L1 to Ln). A mesh area string ID is an identifier for the mesh areas included in a retrieved mesh area string. Taking the search result 1200-5 as an example, the mesh area string with respect to the line L5 is “M₁₅₋₄, M₁₅₋₅, M₁₆₋₅, M₁₆₋₆, M₁₇₋₆, M₁₇₋₇, M₁₇₋₈, M₁₈₋₈, M₁₈₋₉”.

Reference of the description returns to FIG. 5. The determining unit 503 determines that the line Li does not pass through a vertex of a mesh area if the mesh area including the ending point coordinates of the line Li is present in the mesh area string retrieved. Specifically, for example, the determining unit 503 refers to the search result table 1200 to determine whether a mesh area including the ending point coordinates of the line Li is present.

Taking the line L2 as an example, the determining unit 503 refers to the search result table 1200 to determine whether the mesh area M₁₄₋₁₉ including the ending point coordinates of the line L2 is present. Here, since the mesh area M₁₄₋₁₉ is present, the determining unit 503 determines that the line L2 does not pass through a vertex of a mesh area.

Taking the line L5 as an example, the determining unit 503 refers to the search result table 1200 to determine whether the mesh area M₁₉₋₁₁ including the ending point coordinates of the line L5 is present. Here, since the mesh area M₁₉₋₁₁ is not present, the determining unit 503 determines that the line L5 passes through a vertex (reference numeral 801 in FIG. 8) of a mesh area.

The technique of determining whether the line Li passes through a vertex of a mesh area is not limited to the one described above. Specifically, for example, the determining unit 503 may assign the vertex coordinate of each of the mesh areas M₁₋₁ to Mₘ₋ₘ to the equation representing the line Li to determine whether the equality is true. In this case, the determining unit 503 determines that the line Li passes through the vertex of the mesh area if the equality is true.

The output unit 507 has a function of outputting the search results with respect to the line Li as the wiring model if it is determined that the line Li does not pass through the vertex of the mesh area. Here, the wiring model is information expressing the line Li in a simplified form by the mesh area string. Specifically, for example, the output unit 507 may output the search results 1200-2 of the line L2 as the wiring model of the line L2.

The form of output, for example, may be display on the display 208, print out by the printer 213, and transmission to external devices by way of the I/F 209. The search results may be stored in a storage device such as the RAM 203, the magnetic disk 205, and the optical disk 207.

The output unit 507 has a function of outputting the line Li as a non-continuous line when it is determined that the line Li passes through the vertex of the mesh area.

Here, the non-continuous line is a line by which the wiring model is recognized as non-continuous. Specifically, for example, the output unit 507 may output non-continuous line report information listing the line ID of the line Li determined as passing through a vertex of a mesh area.

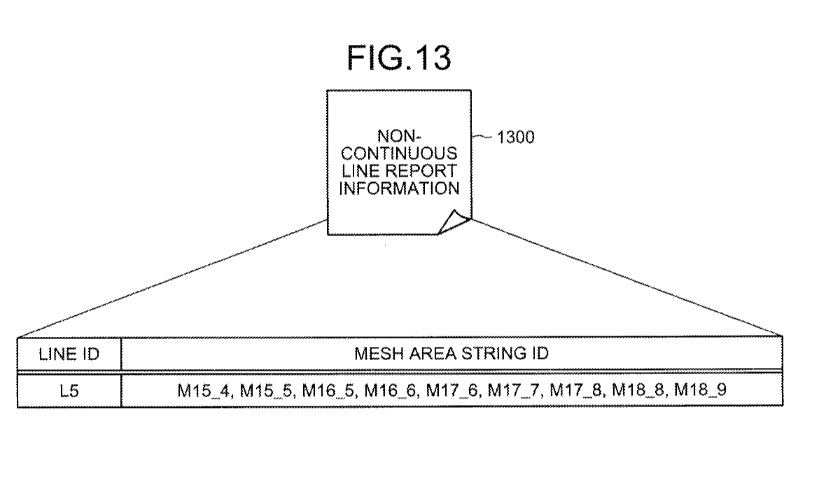

FIG. 13 is an explanatory diagram of one example of non-continuous line report information. In FIG. 13, non-continuous line report information 1300 indicates the line ID and the mesh area string ID correlated to each other. Here, the line ID is an identifier of the line Li passing through a vertex of a mesh area. The mesh area string ID is the search results with respect to the line Li passing through a vertex of a mesh area.

The non-continuous line report information 1300 enables identification of the line Li passing through a vertex of a mesh area, namely, the line Li by which the wiring model is recognized as non-continuous at the analysis tool. The non-continuous line report information 1300 further enables identification of the location at which the wiring model is non-continuous, via reference to the mesh area string ID.

A technique will be described of compensating the location at which the wiring model is non-continuous.

In FIG. 5, the changing unit 506 has a function of changing the mesh coordinate to a coordinate different from the predetermined coordinate within the layout area if it is determined that the mesh area including the ending point coordinates of the line Li is not present in the mesh area string retrieved. Specifically, for example, the changing unit 506 shifts the mesh origin by a first offset amount in the direction of the X axis and at the same time, shifts the mesh origin by a second offset amount in the direction of the Y axis.

Here, the first and the second offset amounts are values based on the mesh width and may be obtained using, for example, equations (5) and (6) below, where ΔX is the first offset amount, ΔY the second offset amount, M the mesh width, and β an arbitrary constant.

ΔX=M/β (5)

ΔY=ΔX/2 (6)

The dividing unit 502 segments the layout area of the circuit-under-test 300 by a predetermined width into a grid pattern to divide the layout area into plural mesh areas, using (as the mesh origin) the coordinate to which the changing unit 506 changed the mesh coordinate. Here, if β above is assumed to be “β=5”, the first offset amount ΔX is obtained as “ΔX=1/5” and the second offset amount is obtained as “ΔY=1/10”.

That is, the coordinate of the mesh origin is (X, Y)=(1/5, 1/10). In this case, the dividing unit 502 divides the layout area of the circuit-under-test 300 by the mesh width of 0.1 [mm] into a grid pattern to divide the layout area into plural mesh areas, using (as a reference) the mesh origin after the change by the changing unit 506.

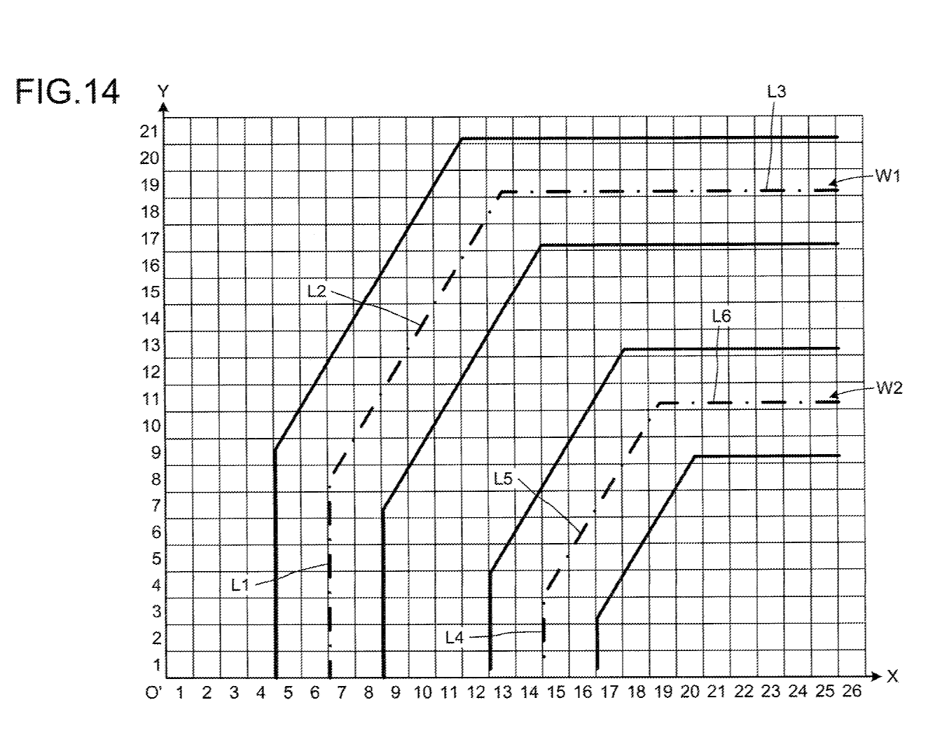

FIG. 14 is an explanatory diagram of another example of mesh area division. In FIG. 14, the layout area of the circuit-under-test 300 is divided by the mesh width of 0.1 [mm] into plural mesh areas, with point O′ (1/5, 1/10) regarded as the mesh origin. A portion of the circuit-under-test is depicted in FIG. 14.

In the example depicted in FIG. 14, since the position of the mesh areas M₁₋₁ to Mₘ₋ₘ changes corresponding with the change (point O→point O′) of the mesh origin, the line L5 does not pass through a vertex of a mesh area. Results of the division are stored to a storage device such as RAM 203, the magnetic disk 205, and the optical disk 207 in, for example, the same data format as that of the mesh position information 700 depicted in FIG. 7.

In the following description, the mesh areas resulting from division of the layout area using the predetermined coordinate (here, point O) as a reference are expressed as “first mesh area group”. The mesh areas resulting from division of the layout area using a different coordinate (here, point O′) as a reference are expressed as “second mesh area group”.

Reference of the description returns to FIG. 5. The detecting unit 504 detects from the second mesh area group M₁₋₁ to Mₘ₋ₘ, the mesh area that includes the starting point coordinates (Xsi, Ysi) of the line Li, the mesh area that includes the ending point coordinates (Xei, Yei) of the line Li, and mesh areas having two or more boundary lines intersected by the line Li.

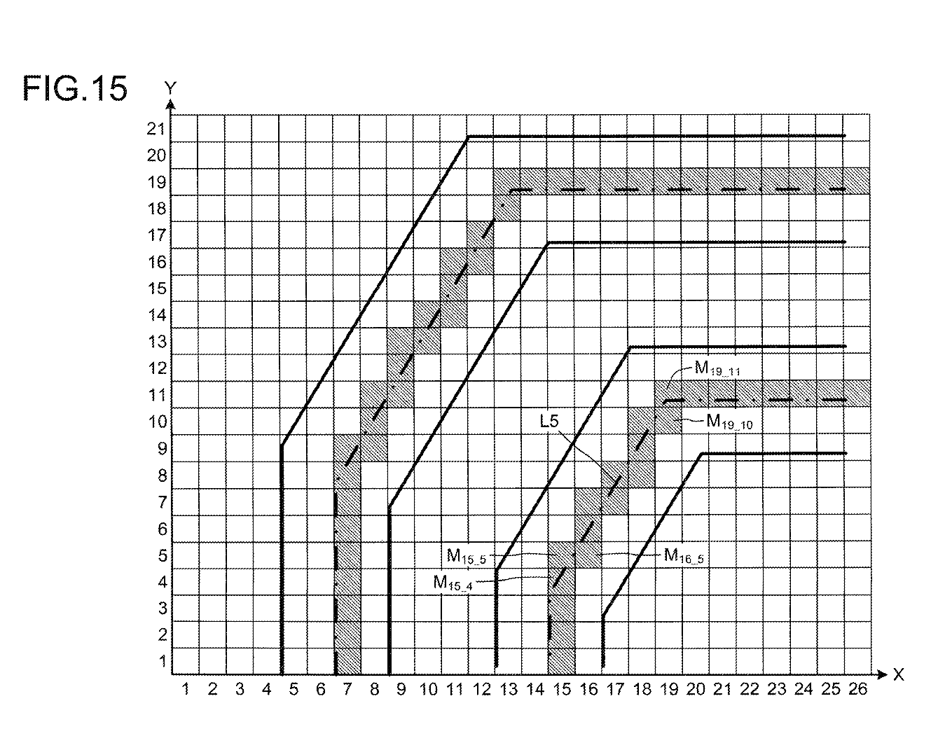

FIG. 15 is an explanatory diagram of another example of mesh area detection. In FIG. 15, the detection example (hatched area in FIG. 15) is depicted with respect to the lines L1 to L3 included in the wiring path W1 and the lines L4 to L6 included in the wiring path W2.

Taking the line L5 as an example, detection is depicted of the mesh area M₁₅₋₄ that includes the starting point coordinates of the line L5 and the mesh area M₁₉₋₁₁ that includes the ending point coordinates of the line L5. Further, the mesh areas M₁₅₋₅, M₁₆₋₅, . . . , M₁₉₋₁₀ are detected as mesh areas having two or more boundary lines intersected by the line L5.

In the following description, the mesh areas detected from the first mesh area group are expressed as “first detection results” and the mesh areas detected from the second mesh area group are expressed as “second detection results”. The second detection results are stored to a storage device such as RAM 203, the magnetic disk 205, and the optical disk 207 in, for example, the same data format as that of the first detection result table 900 depicted in FIG. 9.

The searching unit 505 searches the first and the second detection results, for a mesh area string, starting from the mesh area that includes the starting point coordinates of the line Li and successively tracing adjacent mesh areas sharing a boundary line. Specifically, for example, the searching unit 505 merges the first detection results (see, e.g., FIG. 8) and the second detection results (see, e.g., FIG. 15).

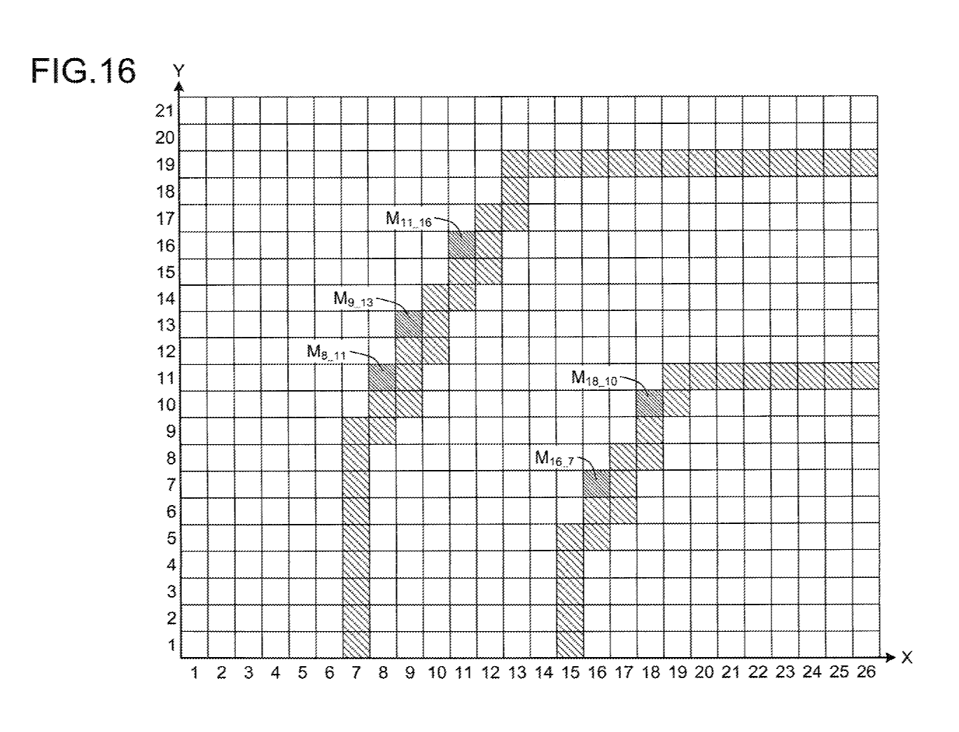

FIG. 16 is an explanatory diagram of an example of merging the first and the second detection results. In FIG. 16, the merging example (hatched portion in FIG. 16) is depicted with respect to the lines L1 to L3 included in the wiring path W1 and the lines L4 to L6 included in the wiring path W2. Specifically, additional mesh areas (the mesh areas M₈₋₁₁, M₉₋₁₃, M₁₁₋₁₆, M₁₆₋₇, and M₁₈₋₁₀) are included as compared with the detection example depicted in FIG. 8.

The searching unit 505 then searches the detection results after the merging of the first and the second detection results, for a mesh area string, starting from the mesh area that includes the starting point coordinates of the line Li and successively tracing adjacent mesh areas sharing a boundary line.

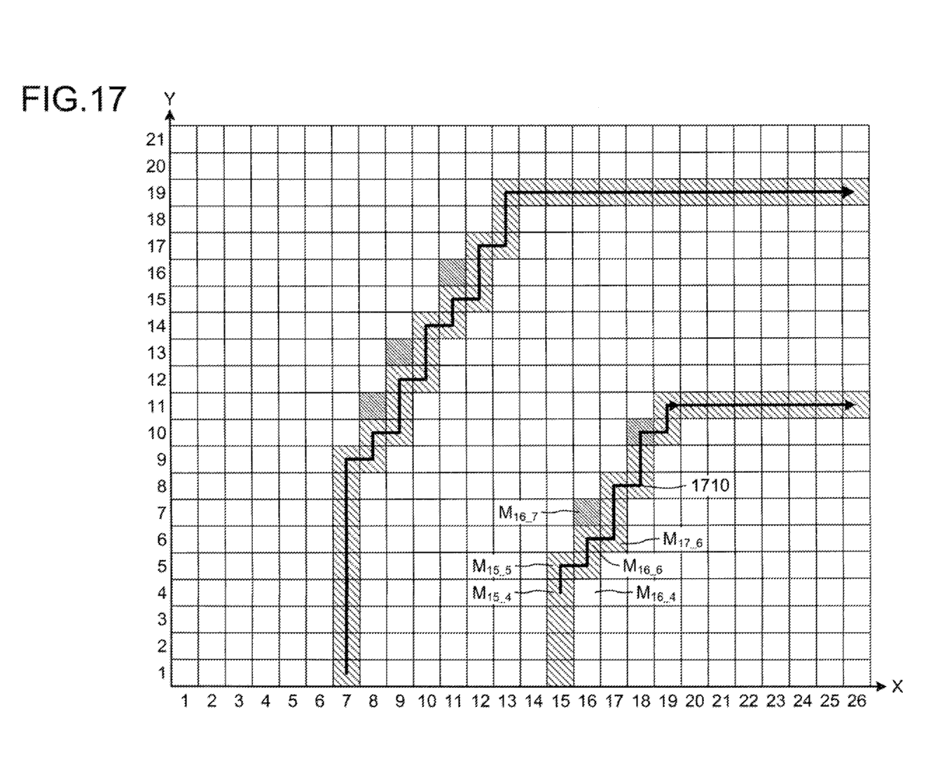

An example will be described of searching for the mesh area string, taking the line L5 as an example. The slope S5 of the line L5 is positive. FIG. 17 is an explanatory diagram of another example of searching for the mesh area string. In FIG. 17, route 1710 represents results of a search originating at the mesh area M₁₅₋₄ including the starting point coordinates of the line L5.

Specifically, the searching unit 505 firstly retrieves the mesh area M₁₅₋₅ for which the line flag of the line L5 is “1”, from among the mesh areas M₁₆₋₄ and M₁₅₋₅ adjacent to the mesh area M₁₅₋₄ that includes the starting point coordinates of the line L5. Thereafter, the processing is repeated until each of the line flags of the mesh areas to be searched are “0”.

When there are plural mesh areas to be searched for which the line flag is “1”, the searching unit 505 may select an arbitrary mesh area or select from among the mesh areas to be searched, according to a pre-set priority order with respect to the first and the second detection results. Here, it is assumed that the priority order of the first detection results is set higher than that of the second detection results.

In the detection example depicted in FIG. 17, the mesh area M₁₆₋₇ and the mesh area M₁₇₋₆ are to be searched (the line flag is “1”) from the mesh area M₁₆₋₆. In this case, the searching unit 505 selects, for example, the mesh area M₁₇₋₆ that is the first detection results, from among the mesh areas M₁₆₋₇ and M₁₇₋₆ adjacent to the mesh area M₁₆₋₆. Results of the search are stored to, for example, the search result table 1200 depicted in FIG. 12.

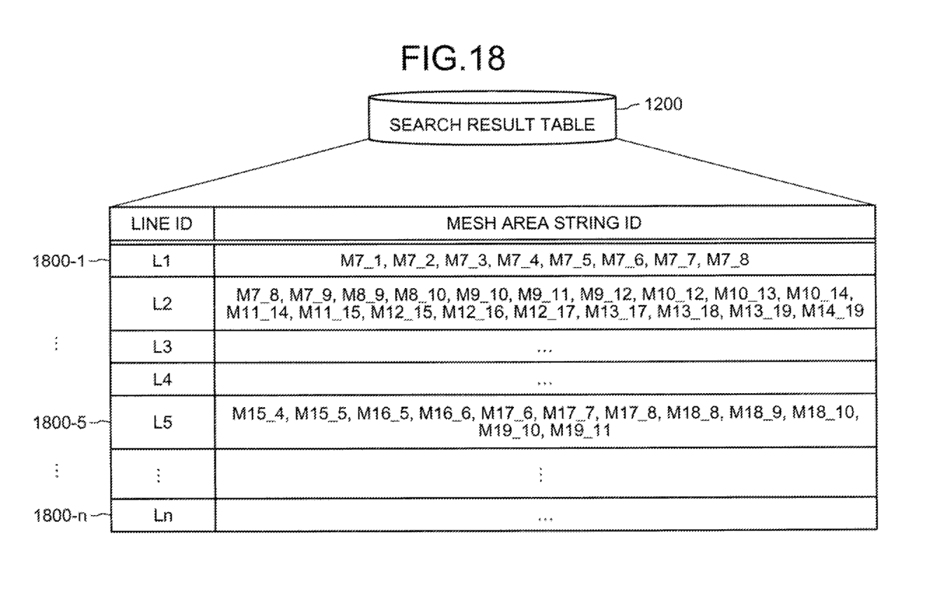

FIG. 18 is an explanatory diagram of another example of the contents of the search result table. In FIG. 18, the search result table 1200 includes the search results 1800-1 to 1800-n. Here, taking the search result 1800-5 as an example, additional mesh areas (the mesh areas M₁₈₋₁₀, M₁₉₋₁₀, and M₁₉₋₁₁) are included as compared with the search results 1200-5 depicted in FIG. 12.

The determining unit 503 refers to the search result table 1200 to determine whether the mesh area M₁₉₋₁₁ including the ending point coordinates of the line L5 is present. Here, since the mesh area M₁₉₋₁₁ is present, the determining unit 503 determines that the line L5 does not pass through a vertex of a mesh area.

In this case, configuration may be such that the output unit 507 outputs, for example, the search results 1800-5 for the line L5, whereby it becomes possible to provide a wiring model of the line L5, for which continuity has been compensated. The output unit 507 collectively outputs the search results for all lines included in the wiring path, enabling a wiring model to be provided for each wiring path.

In the above description, passage of the line Li through a vertex of a mesh area is circumvented by changing the mesh origin from point O to point O′. If (second offset amount/first offset amount) coincides with the slope Si of the line Li, however, the line Li passes through a vertex of a mesh area even if the mesh origin is changed.

Therefore, the changing unit 506 may shift the origin coordinate by the second offset amount based on the mesh width in the direction of the X axis and at the same time, shift the origin coordinate by the first offset amount based on the mesh width in the direction of the Y axis. In the example described above, the coordinate of the mesh origin becomes (X, Y)=(1/10, 1/5).

The dividing unit 502 divides the layout area of the circuit-under-test 300 by the mesh width of 0.1 [mm] into a grid pattern to divide the layout area into plural mesh areas, using the mesh origin after the change as a reference. Thus, the passage of the line Li through the vertex of a mesh area after the change of the mesh origin is circumvented assuredly.

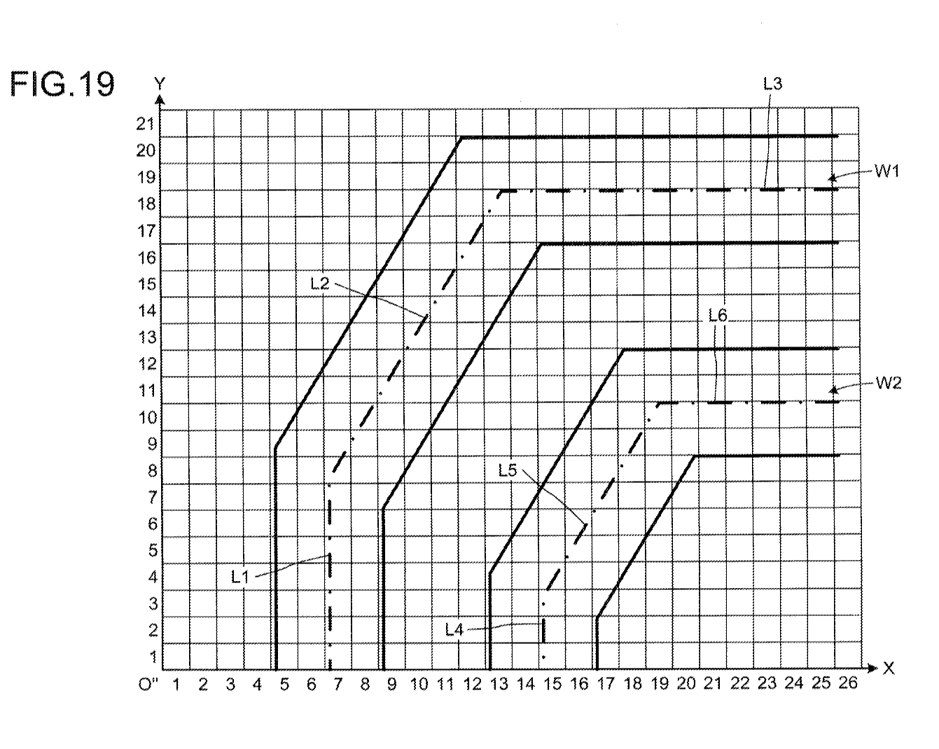

FIG. 19 is an explanatory diagram of another example of mesh area division. In FIG. 19, the layout area of the circuit-under-test 300 is divided by the mesh width of 0.1 [mm] into plural mesh areas, using point O″ (1/10, 1/5) as the mesh origin. A portion of the circuit-under-test is depicted in FIG. 19.

In the following description, the mesh areas resulting from division of the layout area using a different coordinate (here, point O″) as a reference are expressed as “third mesh area group”.

The detecting unit 504 detects from the third mesh area group M₁₋₁ to Mₘ₋ₘ, a mesh area that includes the starting point coordinates (Xsi, Ysi) of the line Li, a mesh area that includes the ending point coordinates (Xei, Yei) of the line Li, and mesh areas having two or more boundary lines intersected by the line Li.

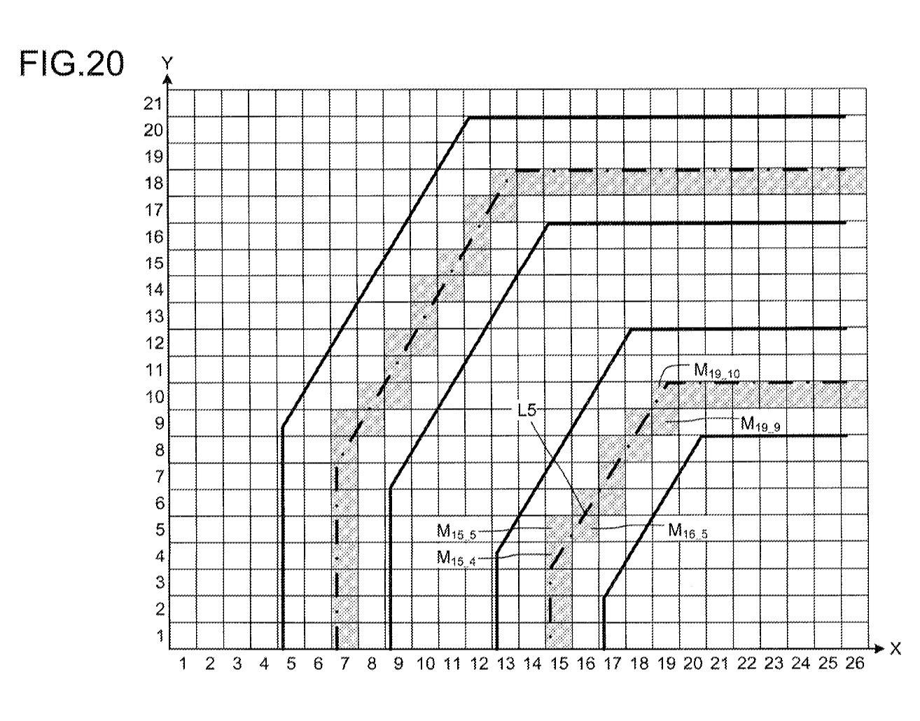

FIG. 20 is an explanatory diagram of another example of mesh area detection. In FIG. 20, the detection example (hatched portion in FIG. 20) is depicted with respect to the lines L1 to L3 included in the wiring path W1 and the lines L4 to L6 included in the wiring path W2.

Taking the line L5 as an example, detection is depicted of the mesh area M₁₅₋₄ that includes the starting point coordinates of the line L5 and the mesh area M₁₉₋₁₀ that includes the ending point coordinates of the line L5. Further, the mesh areas M₁₅₋₅, M₁₆₋₅, . . . , M₁₉₋₉ are detected as mesh areas having two or more boundary lines intersected by the line L5.

In the following description, the mesh areas detected from the third mesh area group are expressed as “third detection results”. The third detection results are stored to a storage device such as RAM 203, the magnetic disk 205, and the optical disk 207 in, for example, the same data format as that of the first detection result table 900 depicted in FIG. 9.

The searching unit 505 searches the first, the second and the third detection results, for a mesh area string, starting from the mesh area that includes the starting point coordinates of the line Li and successively tracing adjacent mesh areas sharing a boundary line. Specifically, for example, the searching unit 505 merges the first detection results (see, e.g., FIG. 8), the second detection results (see, e.g., FIG. 15), and the third detection results (see, e.g., FIG. 20).

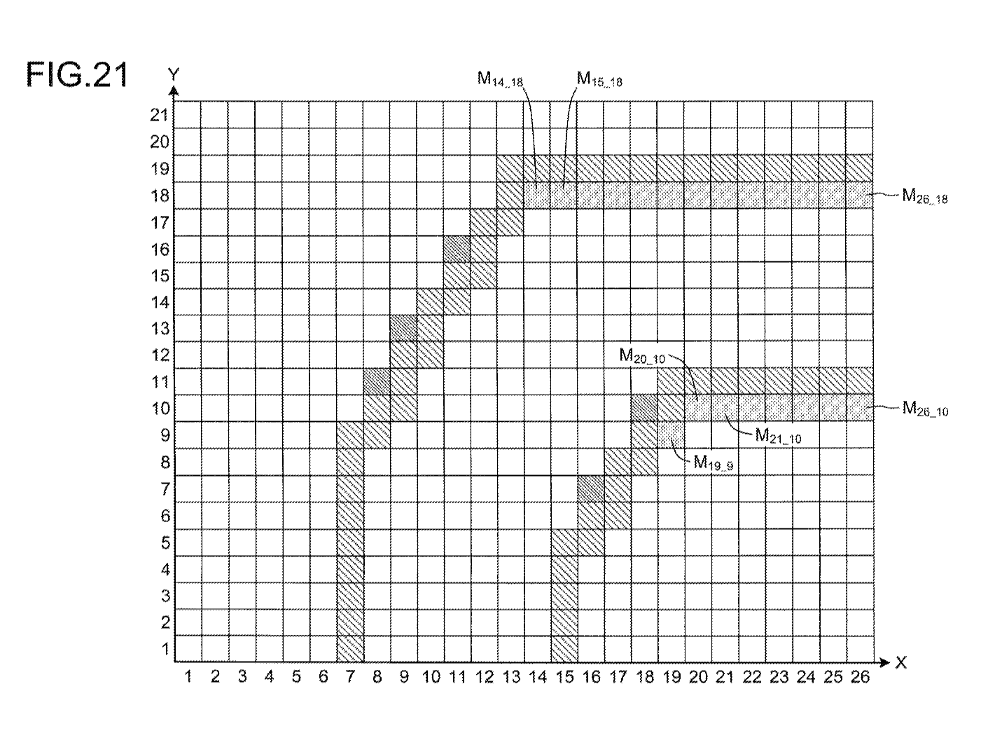

FIG. 21 is an explanatory diagram of an example of merging the first, the second, and the third detection results. In FIG. 21, the merging example (hatched portion in FIG. 21) is depicted with respect to the lines L1 to L3 included in the wiring path W1 and the lines L4 to L6 included in the wiring path W2. Specifically, additional mesh areas (the mesh areas M₁₄₋₁₈, M₁₅₋₁₈, . . . , M₂₆₋₁₈, M₁₉₋₉, M₂₀₋₁₀, M₂₁₋₁₀, . . . , M₂₆₋₁₀) are included as compared with the merging example depicted in FIG. 16.

The searching unit 505 searches the detection results after the merging of the first, the second and the third detection results, for a mesh area string, starting from the mesh area that includes the starting point coordinates of the line Li and successively tracing adjacent mesh areas sharing a boundary line. An example will be described of searching for a mesh area string, taking the line L5 as an example. The slope S5 of the line L5 is positive.

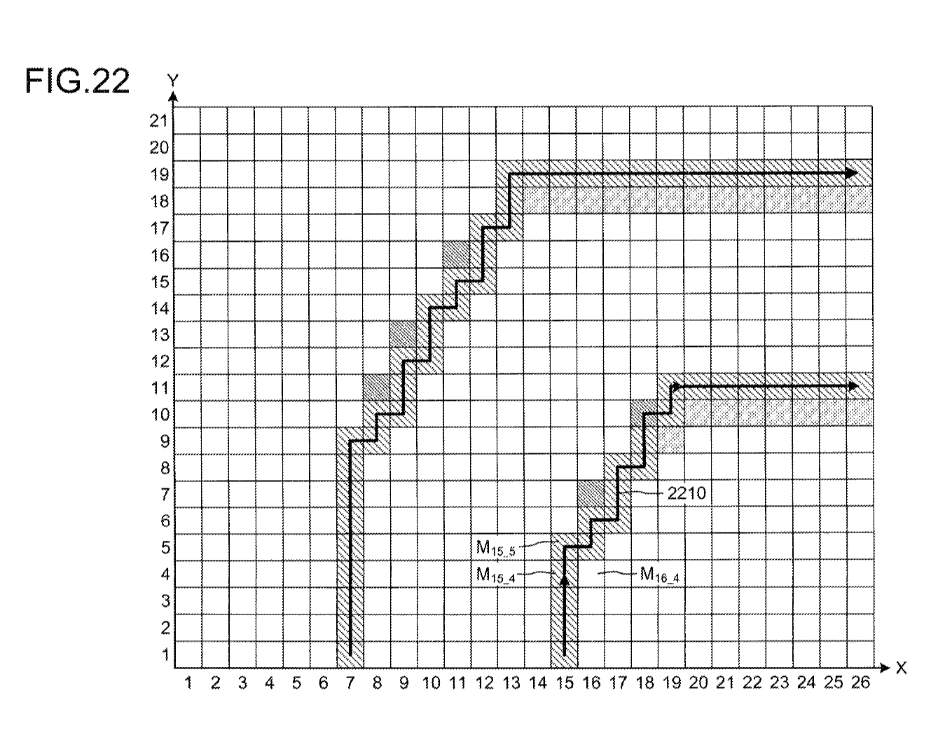

FIG. 22 is an explanatory diagram of another example of searching for a mesh area string. In FIG. 22, route 2210 represents results of a search originating at the mesh area M₁₅₋₄ including the starting point coordinates of the line L5. A priority order of the first, the second, and the third detection results is set as “third detection results→second detection results→first detection results” in ascending order of priority.

Specifically, the searching unit 505 firstly retrieves the mesh area M₁₅₋₅ for which the line flag of the line L5 is “1”, from among the mesh areas M₁₆₋₄ and M₁₅₋₅ adjacent to the mesh area M₁₅₋₄ including the starting point coordinates of the line L5. Thereafter, the processing is repeated until each of the line flags of the mesh areas to be searched are “0”.

In this manner, division of the layout area into the mesh areas after changing the mesh origin O (0, 0) to point O′ (ΔX, ΔY) and point O″ (ΔY, ΔX) enables the passage of the line Li through a vertex of a mesh area to be circumvented assuredly. As a result, the wiring model is provided in which a location recognized as non-continuous by the analysis tool is compensated assuredly.

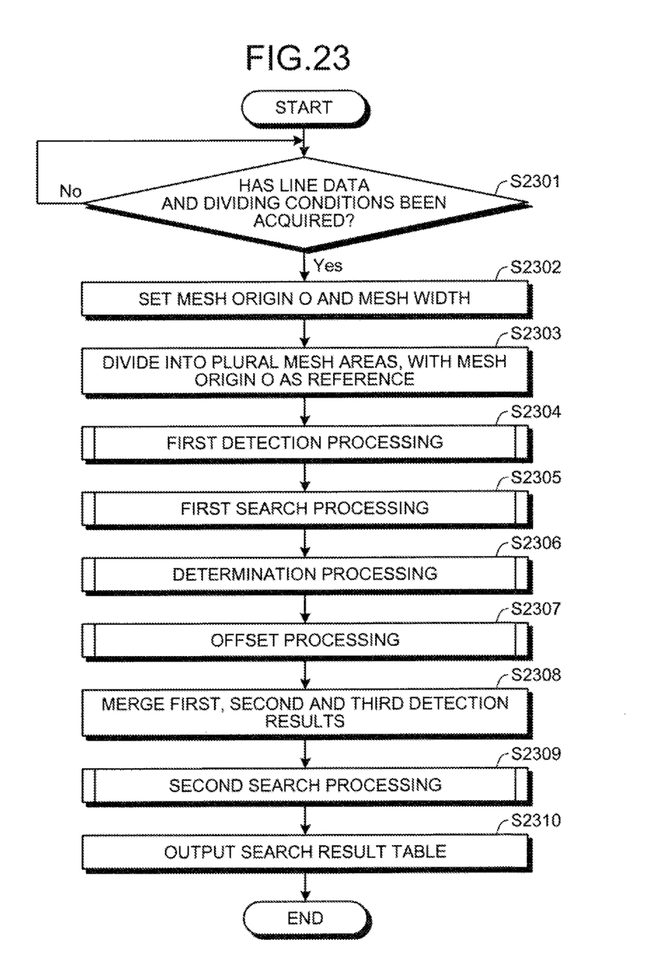

FIG. 23 is a flowchart of one example of a design supporting procedure of the design support apparatus according to the embodiment. In the flowchart of FIG. 23, the acquiring unit 501 firstly judges whether the line data 400-1 to 400-n and the dividing conditions have been acquired (step S2301).

Here, the acquiring unit 501 waits for the line data 400-1 to 400-n and the dividing conditions to be acquired (step S2301: NO) and when acquired (step S2301: YES), the dividing unit 502 sets the mesh origin O and the mesh width, based on the acquired dividing conditions (step S 2302).

The dividing unit 502 then divides, by the mesh width, the layout area of the circuit-under-test 300 into a grid pattern to divide the layout are into plural mesh areas M₁₋₁ to Mₘ₋ₘ, using the mesh origin as a reference (step S2303). The detecting unit 504 then executes first detection processing to detect mesh areas (step S2304) and the searching unit 505 executes first search processing to search for a mesh area string (step S2305).

The determining unit 503 executes determination processing to determine whether the line Li passes through a vertex of a mesh area (step S2306). Thereafter, the changing unit 506 executes offset processing to change the mesh origin (step S2307).

The searching unit 505 then merges the first, the second, and the third detection results (step S2308) and executes second search processing (step S2309). Lastly, the output unit 507 outputs the search result table 1200 (step S2310), ending a sequence of processing according to the flowchart.

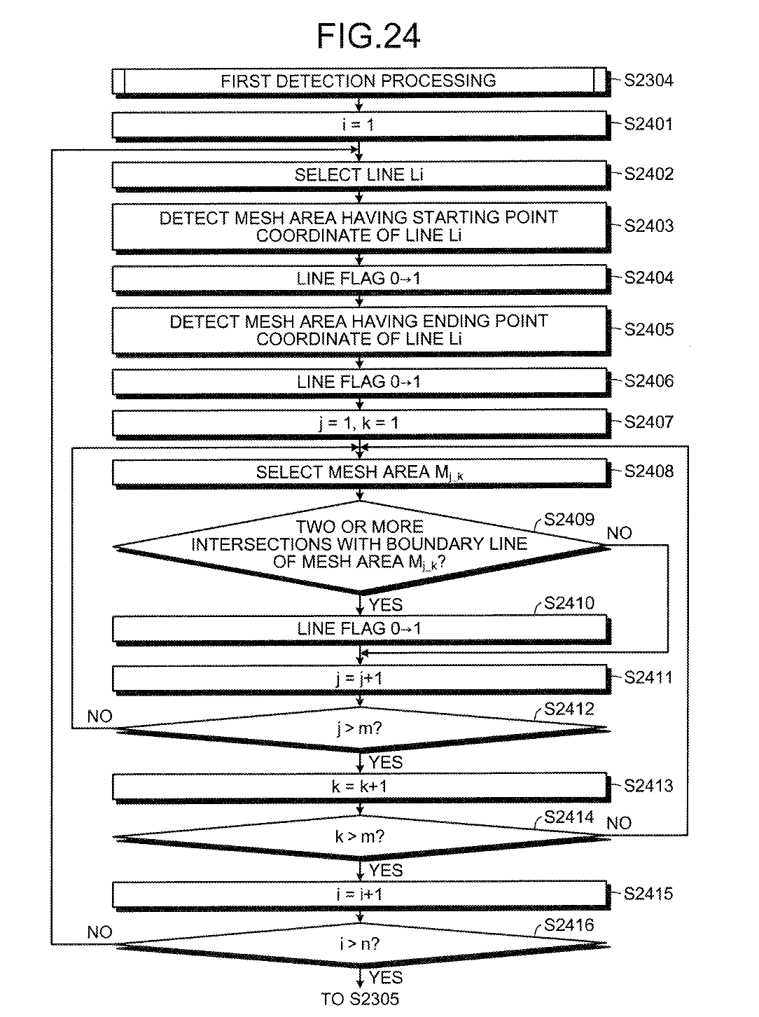

FIG. 24 is a flowchart of one example of the first detection processing at step S2304. In the flowchart of FIG. 24, the detecting unit 504 firstly sets “i=1” (step S2401) and selects a line Li from among the lines L1 to Ln (step S2402).

The detecting unit 504 then detects the mesh area that includes the starting point coordinates of the line Li (step S2403). The detecting unit 504 sets the corresponding line flag of the line Li in the first detection result table 900 to “1” (step S2404).

The detecting unit 504 then detects the mesh area that includes the ending point coordinates of the line Li (step S2405). The detecting unit 504 sets the corresponding line flag of the line Li in the first detection result table 900 to “1” (step S2406).

Thereafter, the detecting unit 504 sets “j=1, k=1” (step S2407) and selects the mesh area Mⱼ_{_{—}}ₖ from among the mesh areas M₁₋₁ to Mₘ₋ₘ (step S2408). The detecting unit 504 then judges whether there are two or more intersections of the line Li with boundary lines of the mesh area Mⱼₖ (step S2409).

Here, if there are two or more intersections by the line Li (step S2409: YES), the detecting unit 504 sets the corresponding line flag of the line Li in the first detection result table 900 to “1” (step S2410). On the other hand, if there are less than two intersections (step S2409: NO), the flow goes to step S2411.

The detecting unit 504 then increments j (step S2411) and judges whether “j>m” (step S2412). Here, if “j≦m” (step S2412: NO), then the flow returns to step S2408.

On the other hand, if “j>m” (step S2412: YES), the detecting unit 504 increments k (step S2413) and judges whether “k>m” (step S2414). Here, if “k≦m” (step S2414: NO), the flow returns to step S2408.

If “k>m” (step S2414: YES), the detecting unit 504 increments i (step S2415) and judges whether “i>n” (step S2414). Here, if “i≦n” (step S2416: NO), the flow returns to step S2402. On the other hand, if “i>n” (step S2416: YES), the flow goes to step S2305 depicted in FIG. 23.

Consequently, a mesh area having an intersecting relationship with the line Li is detected.

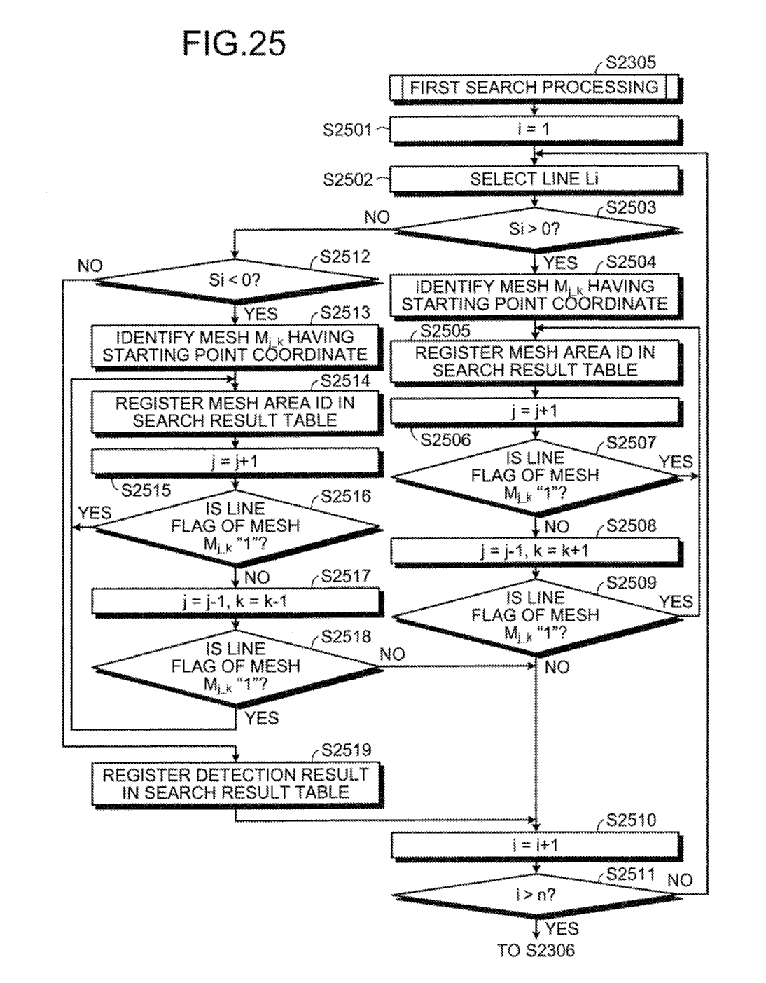

FIG. 25 is a flowchart of one example of the first search processing at step S2305.

In the flowchart of FIG. 25, the searching unit 505 firstly sets “i=1” (step S2501) and selects a line Li from among the lines L1 to Ln (step S2502). Thereafter, the searching unit 505 judges whether the slope Si of the line Li is positive (step S2503).

Here, if the slope Si of the line Li is positive (step S2503: YES), the searching unit 505 refers to the first detection result table 900 to identify the mesh area Mⱼ_{_{—}}ₖ that includes the starting point coordinates of the line Li (step S2504). The searching unit 505 then registers the mesh area ID of the mesh area Mⱼ_{_{—}}ₖ in the search result table 1200 (step S2505).

Thereafter, the searching unit 505 increments j (step S2506) and refers to the first detection result table 900 to judge whether the line flag of the mesh area Mⱼ_{_{—}}ₖ of the line Li is “1” (step S2507). Here, if the line flag is “1” (step S2507: YES), then the flow returns to step S2505.

On the other hand, if the line flag is “0” (step S2507: NO), the searching unit 505 decrements j and increments k (step S2508). The searching unit 505 then judges whether the line flag of the mesh area Mⱼ_{_{—}}ₖ of the line Li is “1” (step S2509).

Here, if the line flag is “1” (step S2509: YES), the flow returns to step S2505. On the other hand, if the line flag is “0” (step S2509: NO), the searching unit 505 increments i (step S2510) and judges whether “i>n” (step S2511).

Here, if “i≦n” (step S2511: NO), the flow returns to step S2502. On the other hand, if “i>n” (step S2511: YES), then the flow goes to step S2306 depicted in FIG. 23.

At step S2503, if the slope Si of the line Li is not positive (step S2503: NO), then the searching unit 505 judges whether the slope Si of the line Li is negative (step S2512).

Here, if the slope Si of the line Li is negative (step S2512: YES), then the searching unit 505 refers to the first detection result table 900 to identify the mesh area Mⱼ_{_{—}}ₖ that includes the starting point coordinates of the line Li (step S2513). The searching unit 505 then registers the mesh area ID of the mesh area Mⱼ_{_{—}}ₖ in the search result table 1200 (step S2514).

Thereafter, the searching unit 505 increments j (step S2506) and refers to the first detection result table 900 to judge whether the line flag of the mesh area Mⱼ_{_{—}}ₖ of the line Li is “1” (step S2516). Here, if the line flag is “1” (step S2516: YES), then the flow returns to step S2514.

On the other hand, if the line flag is “0” (step S2516: NO), the searching unit 505 decrements j and k (step S2517). The searching unit 505 then judges whether the line flag of the mesh area Mⱼ_{_{—}}ₖ of the line Li is “1” (step S2518).

Here, if the line flag is “1” (step S2518: YES), the flow returns to step S2514. On the other hand, if the line flag is “0” (step S2518: NO), the flow goes to step S2510.

At step S2512, if the slope Si of the line Li is not negative (step S2512: NO), then the searching unit 505 refers to the first detection result table 900 to register the detection results 900-i of the line Li in the search result table 1200 (step S2519), and the flow goes to step S2510.

Thus, a string of the mesh areas sharing boundaries is retrieved, starting from the mesh area that includes the starting point coordinates of the line Li. The specific procedure of the second search processing at step S2310 depicted in FIG. 23 is same as that of the first search processing depicted in FIG. 25 and therefore, description thereof is omitted.

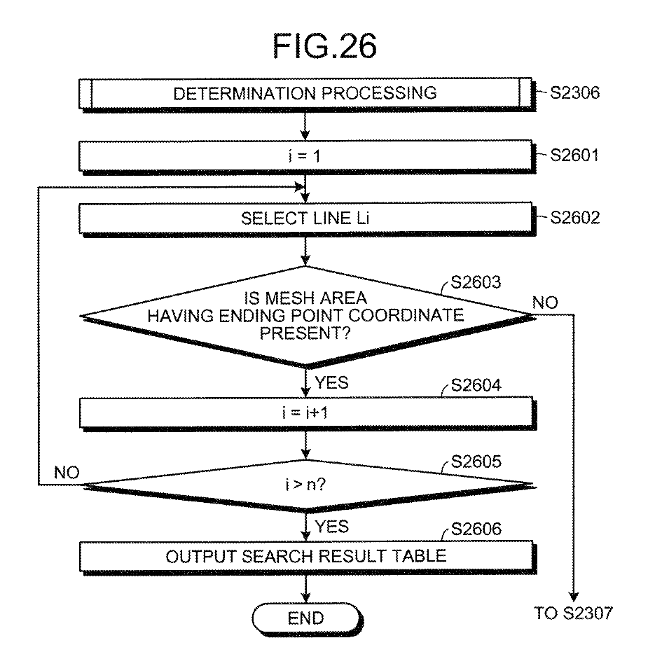

FIG. 26 is a flowchart of one example of the determination processing at step S2306.

In the flowchart of FIG. 26, the determining unit 503 firstly sets “i=1” (step S2601) and selects a line Li from among the lines L1 to Ln (step S2602). The determining unit 503 then refers to the search results 1200-i to judge whether a mesh area that includes the ending point coordinates of the line Li is present (step S2603).

Here, if a mesh area that includes the ending point coordinates of the line Li is present (step S2603: YES), the determining unit 503 increments i (step S2604) and judges whether “i>n” (step S2605).

Here, if “i≦n” (step S2605: NO), then the flow returns to step S2602. On the other hand, if “i>n” (step S2605: YES), the output unit 507 outputs the search result table 1200 (step S2606), ending a sequence of processing.

At step S2603, if a mesh area that includes the ending point coordinates of the line Li is not present (step S2603: NO), the flow goes to step S2307 depicted in FIG. 23.

Thus, the line Li passing through a vertex of a mesh area is identified from among the lines L1 to Ln.

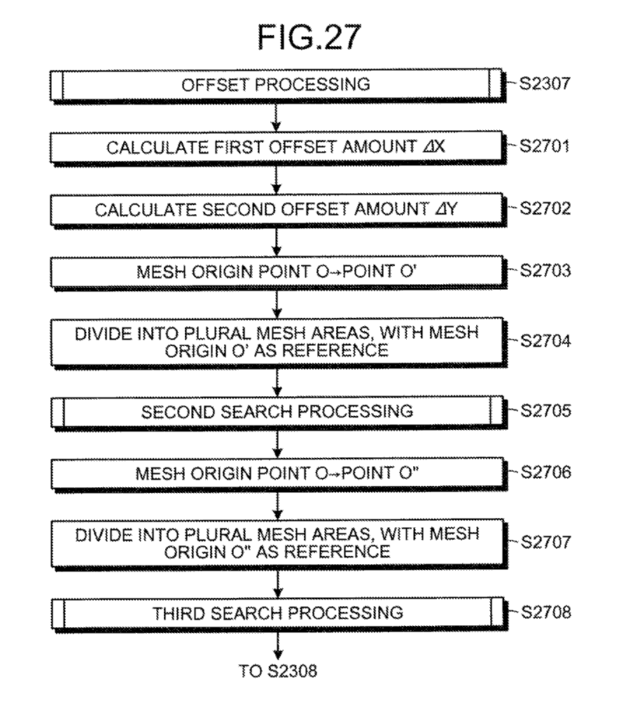

FIG. 27 is a flowchart of one example of the offset processing at step S2307.

In the flowchart of FIG. 27, the changing unit 506 firstly calculates the first offset amount ΔX using equation (5) above (step S2701). The changing unit 506 then calculates the second offset amount ΔY using equation (6) above (step S2702).

The changing unit 506 then changes the mesh origin O to point O′ by shifting the mesh origin by ΔX in the direction of the X axis and at the same time, shifting the mesh origin by ΔY in the direction of the Y axis (step S2703). Thereafter, the dividing unit 502 divides the layout area of the circuit-under-test 300 by the mesh width into a grid pattern to divide the layout are into plural mesh areas M₁₋₁ to Mₘ₋ₘ, using the mesh origin O′ as a reference (step S2704). The detecting unit 504 then executes second detection processing to detect the mesh areas (step S2705).

The changing unit 506 changes the mesh origin O to point O″ by shifting the mesh origin by ΔY in the direction of the X axis and at the same time, shifting the mesh origin by ΔX in the direction of the Y axis (step S2706). Thereafter, the dividing unit 502 divides the layout area of the circuit-under-test 300 by the mesh width into a grid pattern to divide the layout area into plural mesh areas M₁₋₁ to Mₘ₋ₘ, using the mesh origin O″ as a reference (step S2707). The detecting unit 504 then executes third detection processing to detect mesh areas (step S2708). Thereafter, the flow goes to step S2308 depicted in FIG. 23.

Thus, the passage of the line Li through a vertex of a mesh area is circumvented assuredly and mesh areas having an intersecting relationship with the line Li are detected. The specific procedure of the second detection processing at step S2705 and the third detection processing at step S2708 is same as that of the first detection processing depicted in FIG. 24 and therefore, description thereof is omitted.

While a technique has been described of changing the mesh origin to perform the second and the third detection processing and the second search processing with respect to all lines L1 to Ln when at least any one line Li passes through a vertex of a mesh area, the technique is not limited hereto. Specifically, for example, configuration may be such that the mesh origin is changed to perform the second and the third detection processing and the second search processing with respect to only the line Li if the line Li passes through a vertex of a mesh area.

As described above, according to the present embodiment, it is determined whether a line Li passes through a vertex of a mesh area resulting from division of the layout area of the circuit-under-test 300 so that a location recognized as non-continuous by the analysis tool is identified.

According to the present embodiment, a string of adjacent mesh areas sharing boundaries is searched for, starting from the mesh area that includes the starting point coordinates, whereby the continuity of the mesh areas intersected by a line Li are judged and a line Li passing through a vertex of a mesh area is identified.

According to the present embodiment, the mesh origin is changed to shift the position of the mesh areas relative to a line Li recognized as non-continuous so that the passage of the line Li through a vertex of a mesh area is circumvented.

According to the present embodiment, a string of the mesh areas retrieved is output if the concerned line Li does not pass through a vertex of a mesh area so that the wiring model of the line Li provided assures continuity at the analysis tool.

According to the present embodiment, the layout area is divided into mesh areas after changing the mesh origin O (x, y) to point O′ (x+ΔX, y+ΔY) and to point O″ (x+ΔY, y+ΔX) so that the passage of a line Li through a vertex of a mesh area is circumvented assuredly.

According to the present embodiment, when there are plural mesh areas to be searched, the mesh area to be searched is determined based on a pre-set priority order so that a single route may be efficiently retrieved that starts at the mesh area including the starting point coordinates and arrives at the mesh area including the ending point coordinates.

According to the present embodiment, the mesh width of the mesh areas is set at a value equal to the wiring width divided by the constant α of 3 or more so that an overlapping of neighboring lines is circumvented at the time of detection of the mesh areas.

Thus, the present embodiments enables reduction of the time and labor involved in the preparation of a wiring model, thereby shortening the design period. Since the continuity of the wiring model is assured, propagation noise analysis is performed accurately and the design quality of the circuit-under-test is enhanced.

In this embodiment, while the above description has been made with a straight-line wiring path taken as a subject, a curved-line wiring path may be taken as a subject in light of its approximation to a straight line at short intervals.

The method explained in the present embodiment may be implemented by execution of a program that is prepared in advance, the program being executed by a computer, such as a personal computer and a workstation. The program is recorded on a computer-readable recording medium such as a hard disk, a flexible disk, a CD-ROM, an MO, and a DVD, and is read out from the recording medium to be executed by a computer. The program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium storing therein a design support program that causes a computer capable of accessing a database, which stores therein respective starting point and ending point coordinates of line segments included in a wiring path of a circuit-under-test, to execute a process comprising:
dividing a layout area of the circuit-under-test, by a predetermined width, into a grid pattern to divide the layout area into plural mesh areas, using a predetermined coordinate within the layout area as an origin coordinate;
determining whether a line segment selected from among the line segments in the database passes through a vertex of a mesh area obtained at the dividing; and
outputting a determination result obtained at the determining.

2. The non-transitory computer-readable recording medium according to claim 1 and storing therein the design support program that causes the computer execute the process further comprising:
detecting from among the plural mesh areas, a mesh area that includes starting point coordinates of the selected line segment, a mesh area that includes ending point coordinates of the selected line segment, and a mesh area having two or more boundary lines intersected by the selected line segment; and
searching the mesh areas detected at the detecting, for a string of mesh areas, starting from the mesh area that includes the starting point coordinates of the selected line segment and successively tracing adjacent mesh areas sharing a boundary line, wherein
the determining includes determining that the selected line segment passes through a vertex of a mesh area, if the mesh area that includes the ending point coordinates of the selected line segment is not present in the string of mesh areas retrieved at the searching.

3. The non-transitory computer-readable recording medium according to claim 2 and storing therein the design support program that causes the computer execute the process further comprising:
changing the origin coordinate to a second coordinate different from the predetermined coordinate if at the determining the selected line segment is determined to pass through a vertex of a mesh area, wherein
the dividing further includes dividing the layout area, using the second coordinate as the origin coordinate,
the detecting further includes detecting from among the plural mesh areas obtained using the second coordinate as the origin coordinate, a mesh area that includes the starting point coordinates of the selected line segment, a mesh area that includes the ending point coordinates of the selected line segment, and a mesh area having two or more boundary lines intersected by the selected line segment, and
the searching further includes searching the mesh areas detected from among the plural mesh areas obtained using the predetermined coordinate and searching the mesh areas detected from among the plural mesh areas obtained using the second coordinate, for the string of mesh areas.

4. The non-transitory computer-readable recording medium according to claim 2, wherein
the outputting includes outputting the string of mesh areas retrieved at the searching if at the determining, the selected line segment is determined to not pass through a vertex of a mesh area.

5. The non-transitory computer-readable recording medium according to claim 2 and storing therein the design support program that causes the computer to execute the process further comprising:
changing, in an orthogonal coordinate system that includes a first axis and a second axis with respect to the layout area, the origin coordinate to a second coordinate by shifting the origin coordinate by a first distance in a direction along the first axis and by a second distance in a direction along the second axis; and
changing the origin coordinate to a third coordinate by shifting the origin coordinate by the second distance in the direction along the first axis and by the first distance in the direction along the second axis, wherein
the dividing further includes dividing the layout area, using the second coordinate as the origin coordinate, and dividing the layout area using the third coordinate as the origin coordinate,
the detecting further includes detecting from among the plural mesh areas obtained using the second coordinate as the origin coordinate, a mesh area that includes the starting point coordinates of the selected line segment, a mesh area that includes the ending point coordinates of the selected line segment, and a mesh area having two or more boundary lines intersected by the selected line segment, and detecting from among the plural mesh areas obtained using the third coordinate as the origin coordinate, a mesh area that includes the starting point coordinates of the selected line segment, a mesh area that includes the ending point coordinates of the selected line segment, and a mesh area having two or more boundary lines intersected by the selected line segment,
the searching further includes searching the mesh areas detected from among the plural mesh areas obtained using the predetermined coordinate as the origin coordinate, searching the mesh areas detected from among the plural mesh areas obtained using the second coordinate as the origin coordinate, and searching the mesh areas detected from among the plural mesh areas obtained using the third coordinate as the origin coordinate, for the string of mesh areas, and
the outputting includes outputting the string of mesh areas retrieved at the searching.

6. The non-transitory computer-readable recording medium according to claim 5, wherein
the searching, if there are plural mesh areas to be searched, includes determining a mesh area to be searched, based on a pre-set priority order concerning detection results obtained at the detecting from among the plural mesh areas obtained using the predetermined coordinate as the origin coordinate, the detecting from among the plural mesh areas obtained using the second coordinate as the origin coordinate, and the detecting from among the plural mesh areas obtained using the third coordinate as the origin coordinate.

7. A design support apparatus comprising:
a storage unit storing therein respective starting point and ending point coordinates of line segments included in a wiring path of a circuit-under-test;
a dividing unit that divides a layout area of the circuit-under-test, by a predetermined width, into a grid pattern to divide the layout area into plural mesh areas, using a predetermined coordinate within the layout area as an origin coordinate;
a determining unit that determines whether a line segment selected from among the line segments stored in the storage unit passes through a vertex of a mesh area obtained by the dividing unit; and
an output unit that outputs a determination result obtained by the determining unit.

8. A design support method executed by a computer that includes a controller and a storage unit and that is capable of accessing a database storing therein respective starting point and ending point coordinates of line segments included in a wiring path of a circuit-under-test, the method comprising:
dividing, via the controller, a layout area of the circuit-under-test, by a predetermined width, into a grid pattern to divide the layout area into plural mesh areas, using a predetermined coordinate within the layout area as an origin coordinate, the plural mesh areas being stored to the storage unit;
determining, via the controller, whether a line segment selected from among the line segments stored in the database passes through a vertex of a mesh area obtained at the dividing, result of the determining being stored to the storage unit; and
outputting, via the controller, the result of the determining.
